(19) United States
(12) Patent Application Publication
(10) Pub. No.: US 2026/0255124 A1
(43) Pub. Date: Aug. 27, 2026

(54) SELECTIVE ENHANCEMENT OF AUDIO SIGNALS FROM ZONES OF INTEREST

(71) Applicant: Meta Platforms Technologies, LLC, Menlo Park, CA (US)

(72) Inventors: Buye Xu, Sammamish, WA (US); Anjali Induchoodan Menon, Redmond, WA (US); Calvin Murdock, Seattle, WA (US); Ali Aroudi, Kirkland, WA (US); Payal Mohapatra, Redmond, WA (US); Morteza Khaleghimeybodi, Bothell, WA (US); Alexander Reich, Seattle, WA (US)

(21) Appl. No.: 19/446,140

(22) Filed: Jan. 12, 2026

Related U.S. Application Data
(60) Provisional application No. 63/746,543, filed on Jan. 17, 2025.
(60) Provisional application No. 63/762,523, filed on Feb. 24, 2025.

(51) Int. Cl. H04S 7/00; G10L 21/02; G10L 25/78

(52) U.S. Cl. CPC H04S 7/304; G10L 21/02; G10L 25/78

(57) ABSTRACT

A computer-implemented method involves receiving motion data indicative of user motion by a motion sensor of a wearable device. The method includes determining, from the motion data, an auditory zone of interest within an acoustic scene. Audio signals of the acoustic scene are captured via an audio transducer of the wearable device. Audio is rendered to the user with selective enhancement of at least one audio signal of the acoustic scene from the auditory zone of interest relative to other audio signals of the acoustic scene. Various other aspects are also disclosed.

### CROSS REFERENCE TO RELATED APPLICATION

This application claim priority to U.S. Provisional Application No. 63/746,543, filed Jan. 17, 2025, and U.S. Provisional Application No. 63/762,523, filed 24 Feb. 2025, the disclosures of each of which are incorporated, in their entirety, by this reference.

### SUMMARY

In some aspects, the techniques described herein relate to a computer-implemented method, the method including: receiving, by a motion sensor of a wearable device, motion data indicative of user motion; determining, from the motion data, an auditory zone of interest within an acoustic scene; capturing, via an audio transducer of the wearable device, audio signals of the acoustic scene; and rendering audio to the user with selective enhancement of at least one audio signal of the acoustic scene from the auditory zone of interest relative to other audio signals of the acoustic scene.

In some aspects, the techniques described herein relate to a wearable device including: at least one physical processor; a motion sensor communicatively coupled the physical processor; an audio transducer communicatively coupled to the physical processor; and physical memory including computer-executable instructions that, when executed by the physical processor, cause the physical processor to: receive, by the motion sensor, motion data indicative of user motion; determine, from the motion data, an auditory zone of interest within an acoustic scene; capture, via the audio transducer of the wearable device, audio signals of the acoustic scene; and render audio to the user with selective enhancement of at least one audio signal of the acoustic scene from the auditory zone of interest relative to other audio signals of the acoustic scene.

In some aspects, the techniques described herein relate to a non-transitory computer-readable medium including one or more computer-executable instructions that, when executed by at least one processor of a computing device, cause the computing device to: receive, by a motion sensor of a wearable device, motion data indicative of user motion; determine, from the motion data, an auditory zone of interest within an acoustic scene; capture, via an audio transducer of the wearable device, audio signals of the acoustic scene; and render audio to the user with selective enhancement of at least one audio signal of the acoustic scene from the auditory zone of interest relative to other audio signals of the acoustic scene.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a block diagram of a system for identifying auditory zones of interest and intent-aware speech enhancement using smart glasses according to some embodiments of this disclosure.

FIG. 2A is a depiction of a process for IMU data processing, including interaction zone definition and deep learning-based classification according to some embodiments of this disclosure.

FIG. 2B is a graph illustrating raw IMU data and preprocessing to produce robust head-orientation features according to some embodiments of this disclosure.

FIG. 2C is an illustration of a deep learning-based classification module that determines auditory zone of interest from preprocessed motion features according to some embodiments of this disclosure.

FIG. 3 is a mechanical illustration of smart glasses with labeled components, including microphones, cameras, IMUs, a magnetometer, and a barometer according to some embodiments of this disclosure.

FIG. 4 is a graph comparing IMU-derived rotation matrix indices and elevation data against ground-truth measurements to demonstrate minimal drift over time according to some embodiments of this disclosure.

FIG. 5 is a flowchart of a quaternion conversion process for IMU data alignment, calibration, and rotation matrix correction according to some embodiments of this disclosure.

FIG. 6 is a block diagram of feature processing, including feature aggregation, temporal averaging, and application of cross-entropy loss for target prediction according to some embodiments of this disclosure.

FIG. 7 is a graph illustrating accuracy comparisons across various input feature sets and voice activity thresholding methods according to some embodiments of this disclosure.

FIG. 8 is a bar graph illustrating a distribution of spatial location counts across defined azimuth ranges according to some embodiments of this disclosure.

FIG. 9 is a block diagram of a multi-head architecture for feature extraction, fusion, and classification according to some embodiments of this disclosure.

FIG. 10 is a flow diagram of an exemplary method for selectively enhancing audio signals according to embodiments of this disclosure.

FIG. 11 is an illustration of an example artificial-reality system according to some embodiments of this disclosure.

FIG. 12 is an illustration of an example artificial-reality system with a handheld device according to some embodiments of this disclosure.

FIG. 13A is an illustration of example user interactions within an artificial-reality system according to some embodiments of this disclosure.

FIG. 13B is an illustration of example user interactions within an artificial-reality system according to some embodiments of this disclosure.

FIG. 14A is an illustration of example user interactions within an artificial-reality system according to some embodiments of this disclosure.

FIG. 14B is an illustration of example user interactions within an artificial-reality system according to some embodiments of this disclosure.

FIG. 15 is an illustration of an example wrist-wearable device of an artificial-reality system according to some embodiments of this disclosure.

FIG. 16 is an illustration of an example wearable artificial-reality system according to some embodiments of this disclosure.

FIG. 17 is an illustration of an example augmented-reality system according to some embodiments of this disclosure.

FIG. 18A is an illustration of an example virtual-reality system according to some embodiments of this disclosure.

FIG. 18B is an illustration of another perspective of the virtual-reality systems shown in FIG. 18A.

FIG. 19 is a block diagram showing system components of example artificial-and virtual-reality systems.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Conversation-focused audio systems in wearable devices have traditionally assumed that the frontal direction is the desired direction for speech enhancement. This assumption forces users to orient their heads unnaturally toward the active speaker, can drop audio during head transitions and overlapping speech, and often requires camera or continuous audio processing to locate speakers-approaches that are power-hungry, raise privacy concerns, and degrade in noisy, multi-speaker environments. In addition, many solutions treat the problem purely as sound-source localization and overlook user intent, i.e., which speaker the wearer wishes to focus on.

Embodiments of this disclosure address these deficiencies by leveraging motion data from inertial measurement units (IMUs) on smart glasses to infer the wearer's head-orienting behavior and determine zones of auditory interest. From short windows of IMU-derived head orientation, the system predicts the location of conversation partners and selectively enhances audio from those zones while maintaining a world-locked focus independent of instantaneous head pose. By using motion signals rather than always-on cameras or full audio pipelines, the approach preserves privacy and reduces power consumption, remains robust in noisy and overlapping speech scenarios, and incorporates user intent into the enhancement decision. In plain terms, the device learns where the wearer wants to listen based on natural head movements and automatically boosts sound from that direction, delivering clearer conversation without forcing the user to look a certain way or sacrificing battery life.

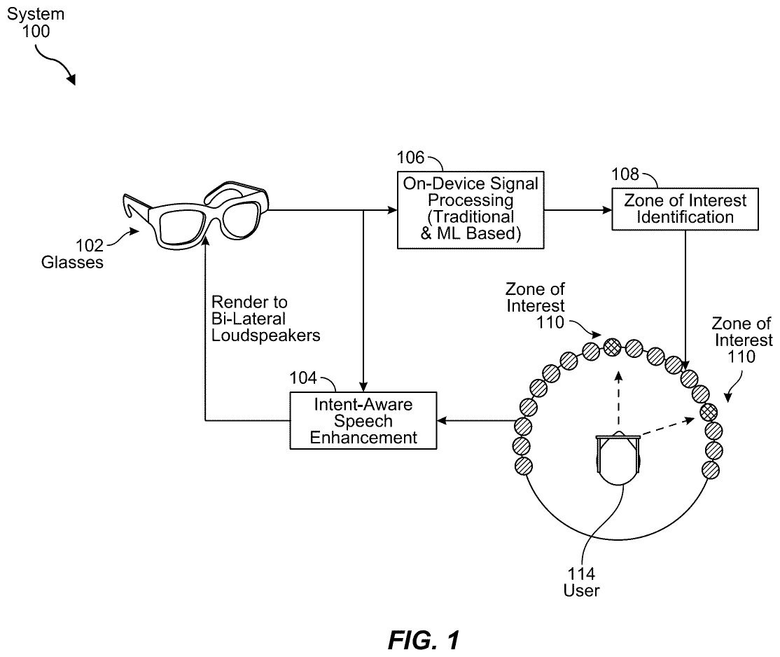

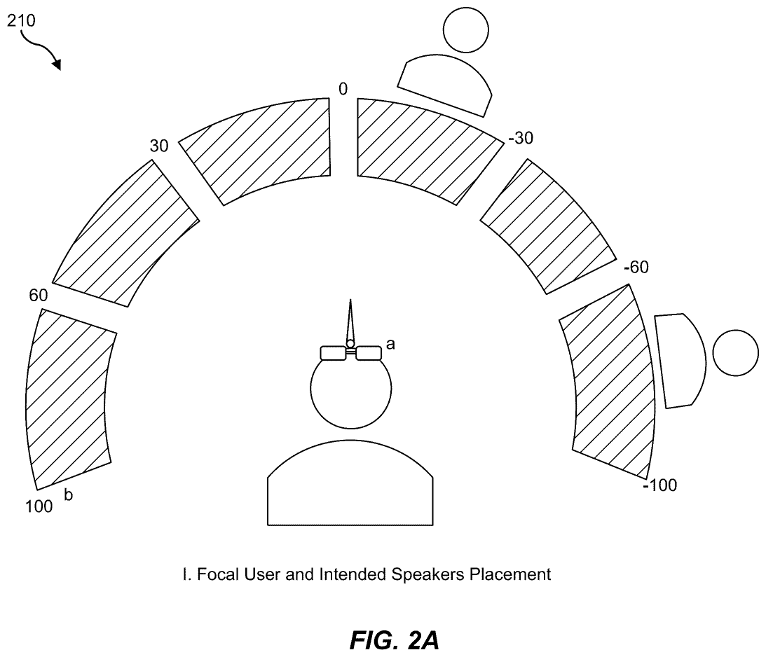

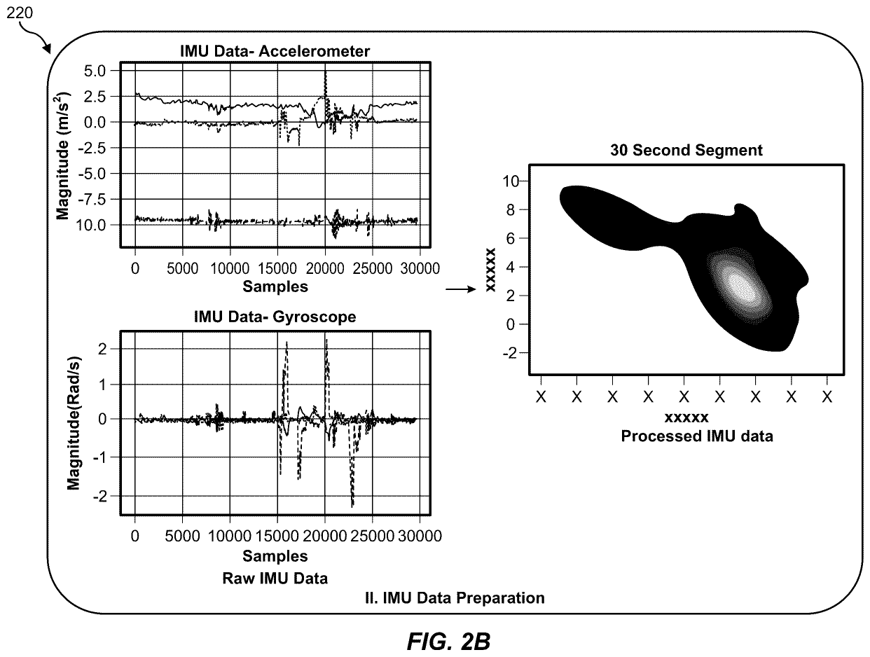

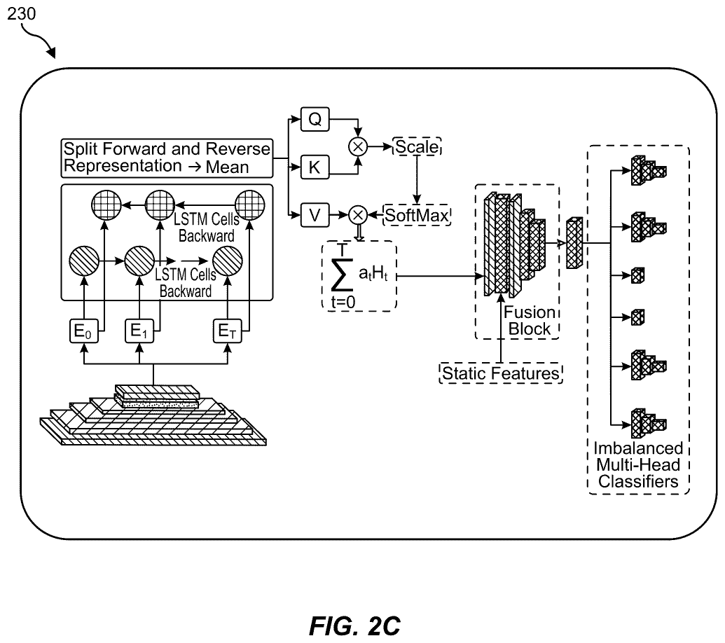

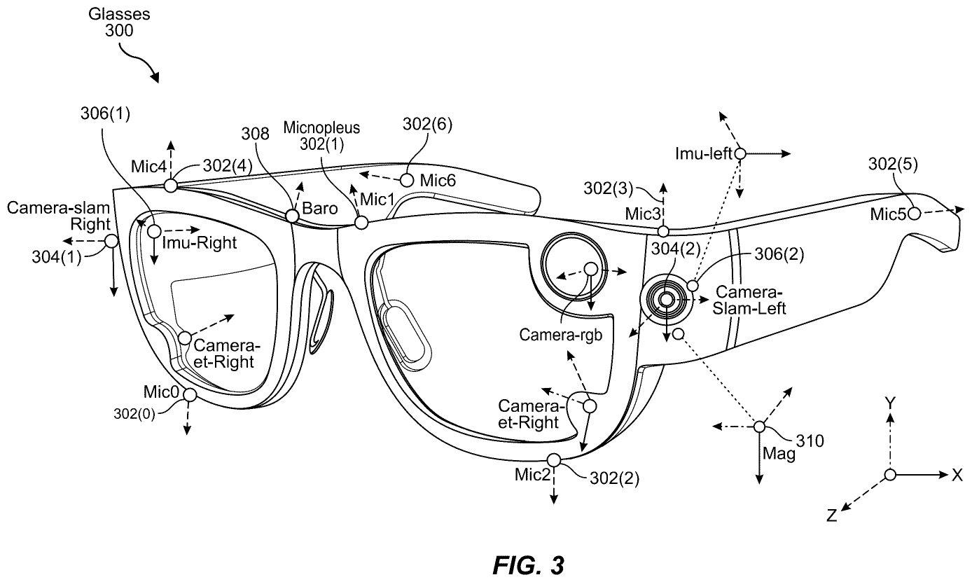

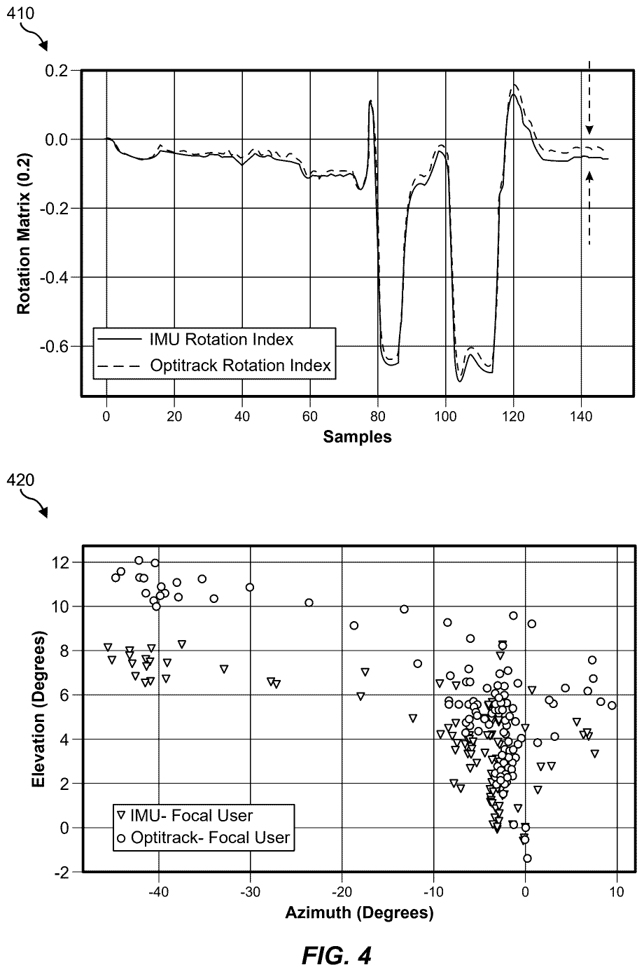

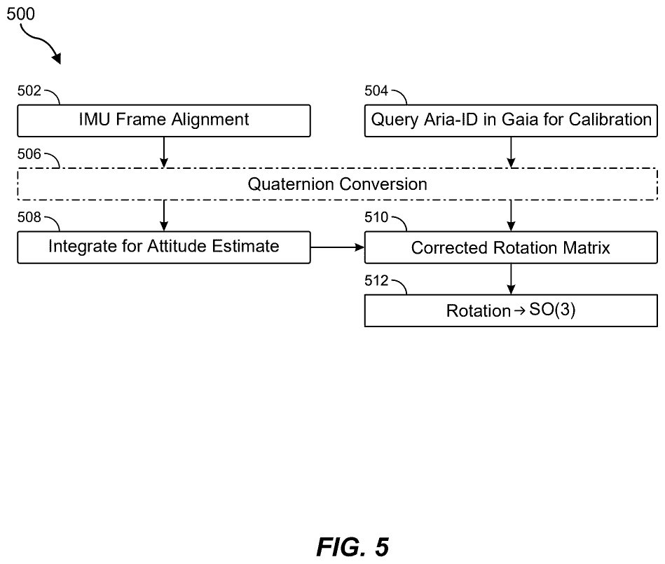

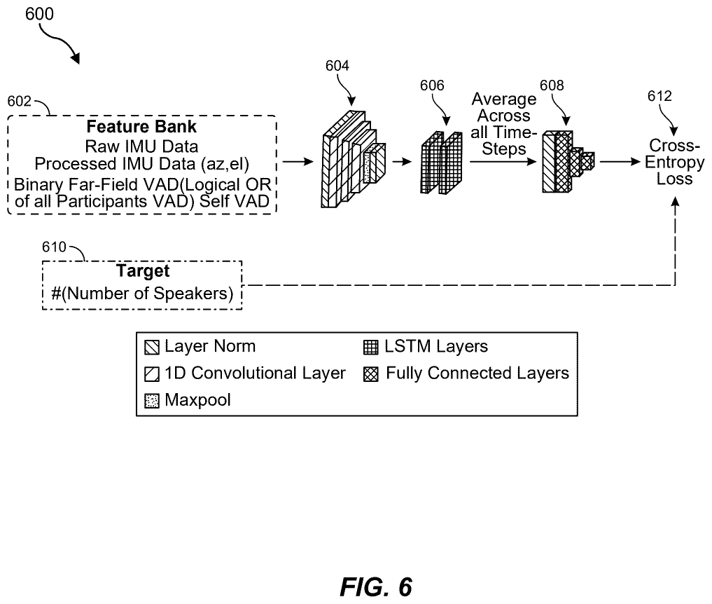

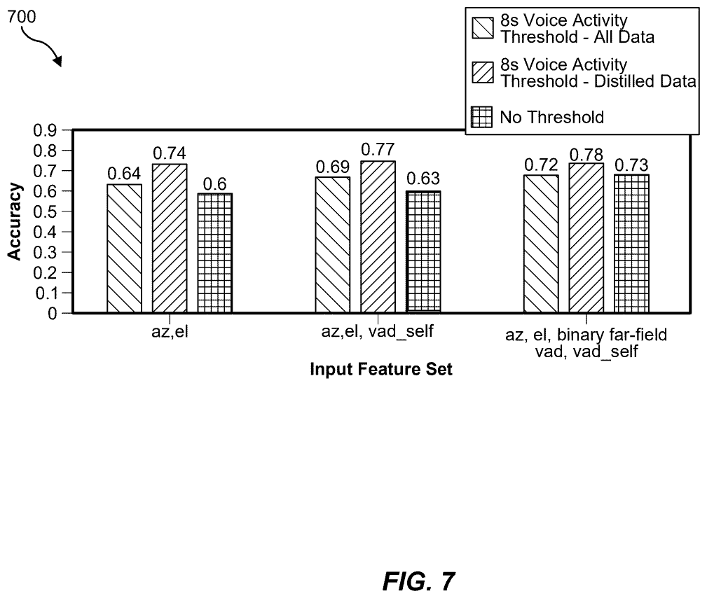

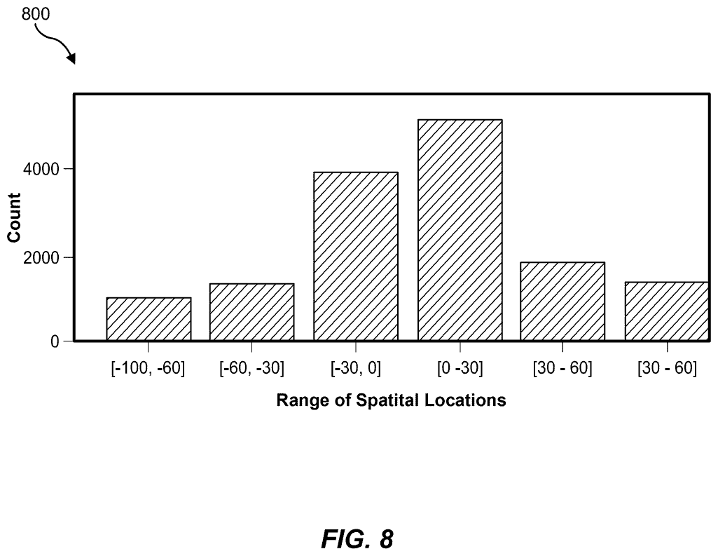

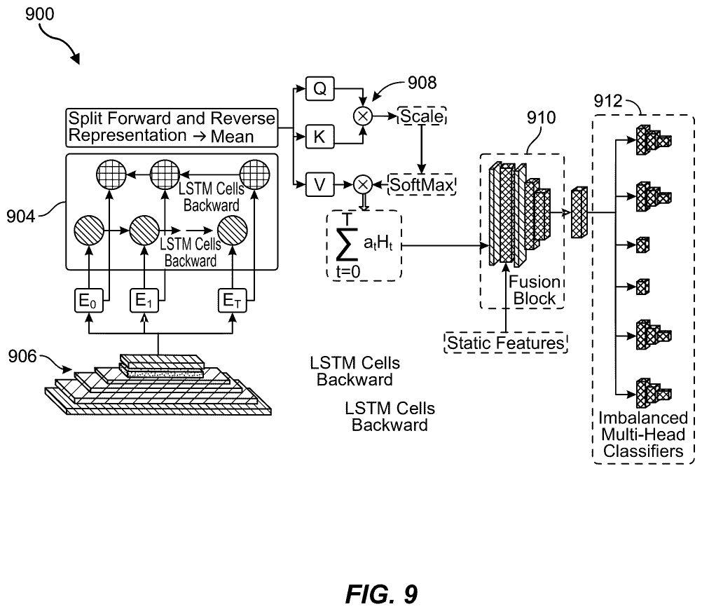

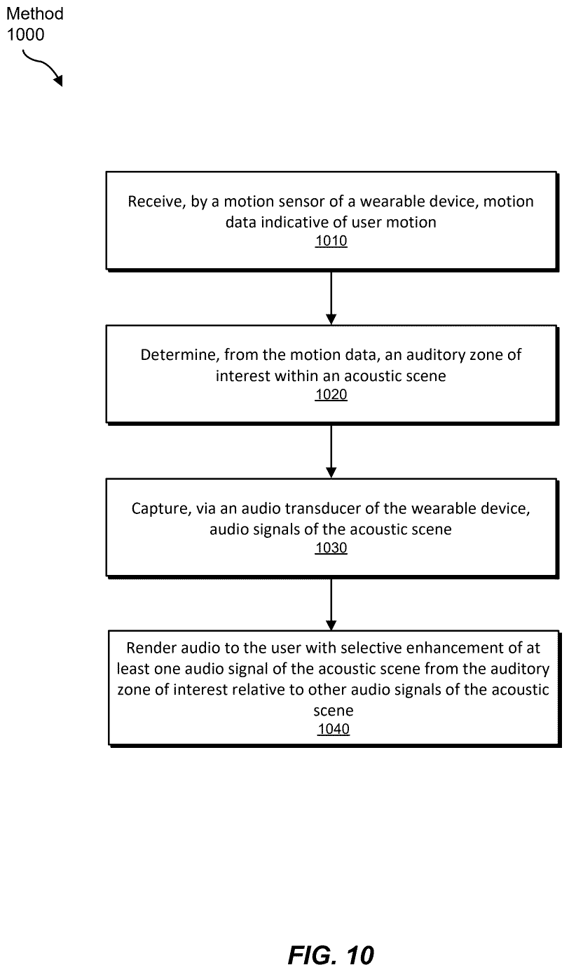

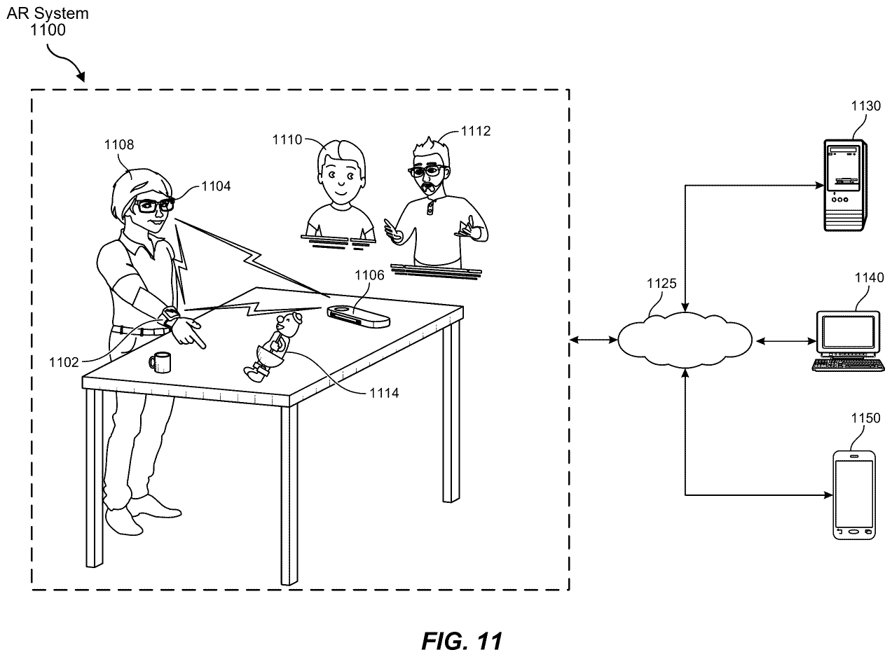

FIGS. 1-10 illustrate example systems and processes for selectively enhancing conversation audio using motion-derived zones of interest on wearable smart glasses. FIG. 1 presents a high-level system diagram showing sensors on the glasses, on-device signal processing, zone-of-interest identification, and intent-aware speech enhancement rendered to bilateral transducers. FIGS. 2A-2C depict the workflow for defining interaction zones, preprocessing IMU signals, and performing deep learning-based classification. FIG. 3 provides a mechanical view of the smart glasses and the placement of microphones, cameras, IMUs, a magnetometer, and a barometer. FIG. 4 compares IMU-derived rotation indices and elevation against ground truth to illustrate minimal drift over short windows. FIG. 5 shows a quaternion conversion flow for alignment, calibration, and rotation matrix correction. FIG. 6 details feature processing, aggregation, temporal averaging, and loss for target prediction. FIG. 7 plots accuracy across input feature sets and voice-activity thresholding. FIG. 8 charts azimuth-bin counts for spatial locations. FIG. 9 outlines a multi-head feature extraction, fusion, and classification architecture. FIG. 10 provides a flow diagram of an exemplary method for selectively enhancing audio signals. FIGS. 11-19 provide examples of artificial-reality devices and virtual reality devices in which aspects of this disclosure may be implemented.

Turning to FIG. 1, system 100 illustrates a system for identifying auditory zones of interest and intent-aware speech enhancement using smart glasses. The following paragraphs describe each component in the figure, referencing their respective character numbers and labels. Glasses 102 function as a wearable device equipped with multiple sensors, including IMUs, microphone, eye-tracking and gaze sensors, and biosensors. Glasses 102 are designed to collect motion, audio, bio-signals, and visual data from user 114 and the surrounding environment. Data acquired by glasses 102 is used for real-time analysis and interaction, supporting identification of auditory zones of interest. User 114 is the individual wearing glasses 102. Behavioral cues such as head movement and gaze direction are captured by sensors on glasses 102, providing input for determining auditory focus and intent.

Intent-aware speech enhancement 104 processes audio signals captured by glasses 102. This module applies algorithms, including machine learning-based techniques, to selectively enhance audio originating from identified zones of interest. Intent-aware speech enhancement 104 amplifies desired speech signals and suppresses background noise, rendering processed audio to user 114 via bilateral transducers.

Zone of interest identification 108 analyzes data from glasses 102 to determine spatial zones where user 114 directs auditory attention. Zone of interest identification 108 processes head orientation, gaze direction, and other behavioral data to identify relevant zones, which are then used by intent-aware speech enhancement 104 for targeted audio enhancement.

On-device signal processing 106 performs real-time analysis of data collected by glasses 102. On-device signal processing 106 uses signal processing and machine learning algorithms to process motion, audio, and visual data, supporting identification of zones of interest and optimization of audio enhancement.

Zone of interest 1 110 represents a spatial area identified as an auditory focus region for user 114. Zone of interest 1 110 is determined based on behavioral cues and is used to guide selective audio enhancement. Zone of interest 2 112 is another spatial area identified as an auditory focus region for user 114. Zone of interest 2 112, like zone of interest 1 110, is determined from behavioral data and allows the system to enhance audio signals from multiple sources in complex environments.

FIG. 2A presents a detailed, end-to-end workflow for motion-derived identification of at least one auditory zone of interest within an acoustic scene, and for rendering audio to a user with selective enhancement of audio corresponding to that zone relative to other audio. In the first stage (210), a focal user is positioned at the center (or any other focal position) of a discretized acoustic scene partitioned into angular sectors. Two illustrative conversation partners are depicted at azimuth ranges of 0 to −30 degrees and −60 to −100 degrees relative to the user's frontal direction, demonstrating how discrete sectors (e.g., azimuth bins) can represent likely source locations in a multi-speaker conversation. The wearable device includes at least one motion sensor that receives motion data indicative of user motion. In common embodiments, this motion sensor is an inertial measurement unit (IMU) comprising a gyroscope (for angular rate), an accelerometer (for linear acceleration and gravity vector), and optionally a magnetometer (for absolute heading), all mounted on the frame (e.g., temple arms) to capture head movement with high fidelity. Alternatives include a sensor subsystem configured to fuse motion data from multiple inputs, such as IMU signals, eye-tracking vectors indicative of gaze direction, and camera-based head pose estimates. This multimodal approach allows the device to determine an auditory zone of interest even when one modality is noisy or temporarily unavailable, such as in low-light scenes (vision degraded), high ambient noise (acoustic localization degraded), or in settings where cameras are disabled for privacy.

The second stage in FIG. 2B (220) focuses on raw IMU data and preprocessing to produce robust head-orientation features. In a typical implementation, 6-axis IMU data is sampled at a high rate (e.g., 500-1000 Hz), and gyroscope rates are integrated to quaternions representing head attitude. On-device filtering and drift correction may be applied to mitigate bias and noise, using complementary or Kalman filters and periodic magnetometer or visual re-anchoring for absolute yaw stability. Quaternions are then converted to a time series of rotation matrices, R3×3×T, and projected into spherical coordinates to generate azimuth and elevation traces, Gp∈R2×T. In some examples, the acoustic scene is discretized only in azimuth, which suffices for typical seated conversations; in others, elevation is also leveraged (e.g., to differentiate a seated talker from a standing presenter or to select upper-left versus lower-left sectors in a crowded environment).

To align with other modalities and reduce computational load, the motion features may be down-sampled (e.g., from 1000 Hz to 5-30 Hz), optionally coincident with a video frame rate or gaze sampling rate. Short-duration segmentation (e.g., ~5, 10, or 30 seconds) is employed to limit drift accumulation and provide responsive updates to the zone of interest. In busy environments, adaptive windowing and overlap-add segmentation can be used to update zone decisions smoothly while maintaining continuity, and sensor recalibration (e.g., brief stillness detection to reset accelerometer offsets, magnetometer hard/soft iron compensation) can be performed opportunistically without disrupting user experience.

The third stage in FIG. 2C (230) is a deep learning-based classification module that determines the auditory zone(s) of interest from the preprocessed motion features and, optionally, auxiliary context. A sequence summarization block may stack one-dimensional convolutional layers (e.g., kernel size 3) to capture short-term temporal patterns such as rapid head turns or micro-adjustments in orientation toward a talker. These are followed by temporal layers such as a bidirectional LSTM (BiLSTM), gated recurrent unit (GRU), temporal convolutional network (TCN), or transformer tuned to time-series data, which capture longer-range dependencies like dwell time in a sector or recurring orientation to the same zone. Self-attention can highlight salient moments (e.g., peaks in angular velocity or sustained facing angle), while static context, such as an estimated number of active talkers, a user's conversational state (listening versus speaking), and auxiliary voice-activity information, may be fused via concatenation or learned gating to refine decisions. The output may be a single sector (e.g., one azimuth bin) or a multilabel distribution across sectors, allowing the renderer to steer a beam or apply a spatial blend. In alternative implementations, the model performs continuous angle regression and maps the angle to a nearest sector at render time, or outputs a confidence-weighted distribution across bins to enable graded enhancement (e.g., 70% focus to −30° bin, 30% to −60° bin) when two talkers are competing.

The techniques described herein were validated using a large-scale, natural conversational dataset collected with smart glasses that include inertial measurement units (IMUs). The dataset includes seated group conversations of two to five participants per session, with each session lasting approximately one hour. To emulate realistic listening conditions, eight loudspeakers surrounding the participants present cafeteria noise at four levels, including quiet, 55 dBA, 65 dBA, and 75 dBA, with a balanced distribution across sessions. IMU signals are sampled at high rates (for example, 1000 Hz) from smart glasses, and ground-truth orientation is simultaneously captured using an external motion capture system (for example, 120 Hz OptiTrack measurements) to corroborate IMU-derived orientation. All modalities may be temporally aligned and downsampled to a common rate (for example, 5 Hz) to harmonize processing cadence with short-duration segmentation windows and to facilitate cross-modal consistency. These sessions are segmented into windows of approximately 30 seconds to limit drift accumulation while capturing dwell patterns and repeated returns to a region, as described in FIGS. 2A-2C.

FIG. 3 is a mechanical illustration of smart glasses 300 with sensor placements that support receiving motion data indicative of user motion, capturing audio signals of the acoustic scene, and rendering selectively enhanced audio. Microphones 302(1), 302(2), 302(3), 302(4), 302(5), and 302(6) are distributed around the frame to capture ambient audio and enable directional processing such as beamforming, adaptive noise reduction, and target separation. Example arrangements include front-facing microphones 302(1) and 302(4) for forward field coverage, lateral microphones 302(2) and 302(3) for side pickup and binaural capture, and a lower or inward microphone 302(5) for near-field monitoring (e.g., own-voice detection). Cameras 304(1) and 304(2) may provide egocentric visual context when enabled; IMUs 306(1) and 306(2) measure angular velocity and linear acceleration for head-orientation estimation; magnetometer 310 (MAG) stabilizes yaw for world-locked operation; and barometer 308 (BARO) supplies ambient pressure data for environmental context.

Alternatives include fewer microphones (e.g., two or three) using virtual beamforming, pairing with external earbuds for additional channels, or bone-conduction microphones for robust own-voice sensing in windy environments. Cameras may be included (e.g., left and right stereo cameras) to provide egocentric visual context; while not required for the motion-based method, cameras can offer redundancy for pose estimation, gaze inference, and interaction context, and can be disabled for privacy or power savings. IMUs are mounted on the frame (e.g., one IMU per temple) to measure angular velocity and linear acceleration; a single IMU is sufficient in many designs, while dual IMUs improve robustness to localized mounting variation or temporary vibration. A magnetometer provides heading relative to Earth's magnetic field, stabilizing yaw for world-locked operation; in magnetometer-free designs, periodic re-anchoring using vision or acoustic scene cues can maintain orientation consistency. A barometer may measure ambient pressure for context (e.g., elevation shifts in multi-floor settings), thermal compensation, or environment classification. Audio output devices may include bilateral air-conduction speakers, bone-conduction transducers, or cartilage-conduction devices placed near the ears; these allow rendering audio to the user with selective enhancement of audio corresponding to the auditory zone of interest relative to other audio. In some examples, rendering includes spatialization to match perceived source direction, gain adjustment emphasizing speech bands (e.g., 1-4 kHz), and compression or equalization tuned for intelligibility; in speaking state, the renderer may apply own-voice suppression to avoid feedback and maintain natural speaking comfort.

FIG. 4 presents validation plots comparing IMU-derived orientation to ground-truth measurements over short segments, demonstrating that motion-based zone determination is stable and accurate enough for conversational use cases. Rotation-matrix indices computed from IMU-derived quaternions are plotted over a time window (e.g., ~30 seconds) and overlaid with rotation indices obtained from an external motion capture system (e.g., OptiTrack at 120 Hz). The close agreement shows minimal drift and robust tracking of head attitude during typical conversational motions, including brief turns, micro-adjustments, and dwell periods facing a talker. Final spherical coordinates (azimuth and elevation) derived from the IMU are compared against ground-truth traces, confirming that azimuth traces are stable in seated conversations and that elevation variation, while smaller, can supplement zone inference when multiple sources occupy similar azimuth sectors but different heights. In alternative studies, shorter windows (e.g., 5-10 seconds) are used to increase responsiveness; longer windows (e.g., 60 seconds) yield smoother orientation statistics but benefit from periodic recalibration (magnetometer or brief visual alignment). The demonstrated stability under realistic conditions underpins a method that: receives motion data indicative of user motion; determines, from that motion data, an auditory zone of interest within an acoustic scene; captures audio signals of the acoustic scene via microphones on a wearable device; and renders audio to the user with selective enhancement of the audio signals of the acoustic scene from the auditory zone of interest relative to the other audio signals of the acoustic scene. In practical terms, when two colleagues speak from the user's left and far-left, the system naturally boosts the talker the user is actually orienting toward, maintains that enhancement even if the user momentarily glances elsewhere (world-locked operation), and keeps power and privacy budgets low by relying primarily on motion sensing rather than always-on cameras or continuous audio localization.

In some implementations, head orientation is computed from gyroscope and accelerometer signals via quaternion-based attitude integration followed by projection to spherical coordinates. To illustrate, angular rates are integrated to quaternions representing head attitude, then converted to rotation matrices and projected to azimuth and elevation. This processing pipeline generates head-orientation trajectories that are compared to ground-truth traces from an external motion capture system over short windows (for example, 30 seconds). Agreement between IMU-derived orientation and external measurements was assessed via Bland-Altman analysis, with 95 percent of samples falling within the limits of agreement and mean absolute error suitable for conversational use cases. Short windows (for example, 5-10 seconds) can further reduce drift at the cost of responsiveness, whereas longer windows (for example, 60 seconds) benefit from periodic re-anchoring or magnetometer stability updates. Across these studies, the IMU-derived azimuth tracks are sufficiently stable to enable robust zone determination in seated multi-speaker conversations.

FIG. 5 illustrates a flow for converting raw motion data from a wearable device into robust head-orientation features suitable for determining an auditory zone of interest within an acoustic scene. The process begins with high-rate acquisition of gyroscope and accelerometer signals from at least one motion sensor (e.g., a 6-axis IMU), optionally augmented with a magnetometer to provide absolute heading. Sensor alignment and calibration are performed to remove biases and scale errors, using techniques such as stationary bias estimation, temperature compensation, and hard/soft-iron correction for magnetometers. The calibrated angular rates are integrated into quaternions representing head attitude over time. To preserve stability in yaw and to limit drift over longer durations, complementary or Kalman filtering can be applied, fusing accelerometer gravity vectors and magnetometer heading with the gyroscope integration; in camera-enabled designs, brief visual re-anchoring (e.g., using egocentric frame alignment) may be employed instead of, or in addition to, magnetometer fusion. The quaternion sequence is converted to a rotation-matrix time series, which provides a convenient representation for downstream projection. The rotation matrices are then projected into spherical coordinates to yield azimuth and elevation traces; in typical seated conversations, azimuth alone may suffice, but elevation can be retained to disambiguate sources at similar azimuth with different heights (e.g., a seated talker versus a standing presenter). To reduce computational load and synchronize with other modalities, the features are downsampled (for example from 500-1000 Hz to 5-30 Hz) and segmented into short windows (e.g., 5, 10, or 30 seconds). Short windows help maintain close agreement with ground truth and mitigate drift; when longer windows are used, periodic stillness detection can trigger recalibration without disrupting the user experience. The resulting feature stream includes instantaneous and aggregated descriptors such as azimuth/elevation, angular velocity and acceleration, dwell times in sectors, and trajectory statistics. These features form the motion-based input for determining at least one auditory zone of interest and are resilient to noisy conditions, camera-off privacy modes, and overlapping speech.

FIG. 6 illustrates a feature-processing pipeline and learning objective used to predict auditory zones of interest from head-orientation measurements over a short segment. A feature bank 602 stores processed motion-derived descriptors for azimuth az(t) and elevation el(t), and may include derived quantities such as angular velocity, angular acceleration, dwell time per sector, and trajectory statistics computed over a 30-second window. These descriptors are assembled into processed feature data 604, which organizes the per-time-step measurements into a tensor of shape RB×F×T, where RB is the batch size, F is the feature dimension, and T is the number of time steps in the segment. Aggregated features 606 apply a sequence summarization block consisting of one-dimensional convolutions to capture short-term head-movement patterns (e.g., rapid turns, micro-adjustments) before handing the sequence to a temporal model. In one embodiment, the temporal model comprises two bidirectional LSTM layers that output RB×2F×T, which are split and averaged to produce H of dimension RB×F×T. An average across time steps 608 collapses the sequence to RB×F×1 for downstream classification. Targets 610 are represented as multilabel indicators of the discrete spatial sectors that contain the conversation partners of the focal user, such as the azimuth bins shown in FIG. 8. Cross-entropy loss 612 is applied per sector with class weighting to address underrepresented bins (e.g., peripheral zones), allowing the system to learn robust decision boundaries despite distribution imbalance. Alternatives include replacing the BiLSTM with GRU, TCN, or transformer layers; using attention-weighted pooling instead of simple averaging; or regressing a continuous angle that is mapped to sectors at render time.

In some embodiments, determining the auditory zone(s) of interest is formulated as a multilabel classification task over discrete azimuth sectors, allowing multiple sectors to be jointly active when conversation partners are closely spaced or when user attention alternates across adjacent regions. To construct training targets, the system maps the ground-truth locations of conversation partners to the user's head-locked frame and discretizes the azimuth into sectors. For each segment, the median azimuth of each conversation partner is assigned to the corresponding sector(s), and a logical aggregation produces a multilabel vector indicating all sectors that contain conversation partners during that segment. This discrete spatialization avoids brittle frame-by-frame localization and supports graded enhancement across adjacent sectors during overlap.

In some embodiments, a dedicated head-orientation-based localization network (HALo) is used to predict the multilabel sector distribution from IMU-derived azimuth and elevation trajectories. HALo includes a sequence summarization module using one-dimensional convolutions to capture short-term head-movement patterns, a temporal module (for example, bidirectional LSTM) to capture longer-range dependencies such as dwell time and recurrent orientation, and a self-attention mechanism to weight salient temporal intervals, such as sustained facing or peaks in angular velocity. Static context, such as an estimate of the number of conversation partners, can be fused via concatenation or learned gating to sharpen sector predictions. To address class imbalance that naturally arises in peripheral sectors, the system uses class-weighted objectives and imbalanced classifier heads, with deeper fully connected stacks assigned to underrepresented sectors.

In some embodiments, an auxiliary classification network (CoCo) is used to identify the number of conversation partners from the same head-orientation signal. CoCo processes azimuth and elevation sequences over the segment and outputs the number of conversation partners via a sequence-to-one classifier. Auxiliary low-bit-rate audio indicators (for example, self voice-activity and any-speaker voice-activity) can be optionally included to provide abstract, privacy-preserving context that distinguishes speaking-state and listening-state head movements. In addition, cumulative voice-activity target shaping can be applied to qualify conversation partners based on talkativeness during the segment (for example, accumulating a threshold amount of speaking time), which improves classification robustness in low-activity windows. In one implementation, the system adopts an end-to-end stage-wise training strategy (HALo-CoCo) in which the learned static representation produced by CoCo is fused into HALo to reduce dependence on a priori knowledge of the number of conversation partners.

In some implementations, the system was trained and evaluated under standard procedures conducive to on-device operation. For instance, the data may be split into training, validation, and test sets using multiple random seeds, with batch processing and an adaptive optimizer. Distinct learning rates can be used for localization versus classification tasks, and the best performing checkpoint is selected based on validation loss. During evaluation, multilabel localization performance is measured using metrics such as Hamming score, logit-wise accuracy and F1, and macro-F1 across sectors, while classification of the number of conversation partners is measured using accuracy and macro-F1, enabling fair assessment across imbalanced sector distributions and variable group sizes.

FIG. 7 presents accuracy comparisons across input feature sets and thresholding strategies for auxiliary voice-activity indicators. In one configuration, inputs include az(t) and el(t) alone; in another, low-bit-rate self voice-activity (VAD) and binary far-field VAD streams are added as context to indicate when any speaker is active within the window. The bar plots illustrate that including voice-activity information can improve the multilabel classification accuracy, especially when segments are distilled by applying an 8-second voice-activity threshold to qualify talkers (e.g., removing cases where a participant spoke too briefly to form a stable orientation pattern). In settings with no thresholding, azimuth and elevation features already provide strong performance; adding self/far-field VAD can further stabilize predictions in multi-speaker scenes and during overlap. Variants include different VAD aggregation schemes (e.g., per-speaker versus any-speaker), alternative thresholds (e.g., 5-10 seconds), and confidence-weighted outputs to blend adjacent sectors when two talkers compete.

In some embodiments, baseline methods were implemented to quantify the benefit of the proposed architecture. A rule-based approach using density-based spatial clustering on azimuth samples during the user's non-speaking state was used to form sector clusters and estimate the number of conversation partners; a non-temporal segment-level classifier using a multi-layer perceptron was also evaluated; and a state-of-the-art transformer-based long-sequence forecaster was applied to downsampled IMU streams. Across these baselines, the dedicated sequential architecture with self-attention and sector-class weighting exhibits superior performance, reflecting the importance of preserving temporal ordering and fusing static context. Late fusion of the number-of-partners estimate materially improves sector localization, while abstract audio features and talkativeness-based target shaping provide additional gains for the classification of conversation partners.

FIG. 8 is a bar graph showing the distribution of spatial location counts across six example azimuth ranges: [100, −60], [−60, −30], [−30, 0], [0, −30], [30, 60], and [60, 100]. These ranges reflect a discretized acoustic scene around the focal user. The counts demonstrate that frontal and near-frontal bins (e.g., [−30, 0] and [0, −30]) are naturally more frequent in seated conversations, while extreme left/right bins have fewer samples, leading to class imbalance. This distribution informs the training strategy shown in FIG. 6, where class-weighted cross-entropy and imbalanced classifier heads are employed to ensure adequate sensitivity to peripheral zones. Alternative discretizations may use more or fewer bins, non-uniform bin widths (e.g., narrower near the frontal direction and wider toward extremes), or sectors that include elevation to separate seated and standing talkers.

In some embodiments, the choice of azimuth discretization can be tuned to the application scenario. Fewer sectors (for example, front/left/right) yield higher macro-F1 by concentrating samples into fewer classes, while finer discretizations (for example, six or eight sectors) provide more directional resolution but introduce natural class imbalance at the extremes of the field of view. To mitigate such imbalance, the system combines class-weighted losses, imbalanced heads, and fusion of static context. This discretization framework provides flexibility to match expected seating layouts and downstream rendering policies while maintaining robust classification across multi-speaker scenes.

FIG. 9 details a multi-head architecture for feature extraction, fusion, and classification of auditory zones of interest. A shift forward and reverse differentiation in X matrix 902 represents the bidirectional temporal processing that captures both past and future context around each time step. Static features 904 provide auxiliary inputs, such as an estimated number of conversation partners derived from head-orientation patterns or auxiliary VAD, and can include user state indicators (e.g., listening versus speaking) when available. A feature block 906 applies normalization and sequence summarization (e.g., stacked 1D convolutions) to the RB×F×T input, followed by feature extraction 908 using bidirectional LSTM layers that output RB×2F×T; the forward and reverse streams are combined (e.g., split and mean) to obtain H of dimension RB×F×T. A fusion block 910 concatenates or gates the temporally summarized features with static features, producing RB×(F+S)×1, where S is the static-feature dimension.

This fused representation is passed to imbalanced multi-head classifiers 912, with deeper fully connected stacks assigned to peripheral sectors to counteract data imbalance observed in FIG. 8. Each head outputs a binary decision for its sector, forming a multilabel prediction across the discretized scene. Weighted objectives per head, attention mechanisms over time, and confidence calibration (e.g., temperature scaling) can be used to improve stability and interpretability. Alternatives include replacing the BiLSTM with a transformer encoder that applies self-attention directly over the sequence; using soft sector distributions to enable graded enhancement (e.g., 70% gain to −30° and 30% to −60° when two talkers are active); or incorporating elevation-aware heads when the application benefits from vertical discrimination.

Across FIGS. 6-9, the objective is to predict, from azimuth az(t) and elevation el(t) sequences, which sectors contain the focal user's conversation partners, and to do so as a multilabel binary classification over short segments (e.g., ~30 seconds). This formulation scales to any number of partners without redesign, avoids brittle decomposition of close-seated sources by allowing adjacent sectors to be jointly active, and is resilient to torso motion and transient gestures that can confound frame-by-frame localization. The architecture generates sector decisions at the end of each segment, which can be used directly to render audio to the user with selective enhancement of signals from the predicted sectors relative to other signals, or combined over time to provide world-locked focus independent of instantaneous head pose. In practice, the system adapts to multi-speaker conversations by emphasizing sectors toward which the user naturally orients, maintains enhancement through brief glance shifts, and reserves camera and audio pipelines for auxiliary context when privacy and power budgets permit.

In some embodiments, interpretability analyses corroborate that the learned temporal attention focuses on moments of active engagement. Self-attention weight profiles indicate higher importance when the wearer performs rapid turns or sustained facing toward a sector containing conversation partners, and lower importance when the wearer's head remains static or oriented away from any talker. This interpretability aligns with the design goal of capturing dwell patterns and recurrent orientation over short windows to infer intent-aware auditory zones of interest.

FIG. 10 is a flow diagram of an example method 1000 for selectively enhancing audio signals based on motion-derived zones of interest on a wearable device. Step 1010 involves receiving motion data indicative of user motion from at least one motion sensor of a wearable device, and broadly encompasses any signals or derived states that describe or imply movement, orientation, pose, acceleration, angular rate, or position of the device and/or user. In some embodiments, a 6-axis or 9-axis inertial measurement unit (IMU) mounted on smart glasses samples gyroscope (angular velocity) and accelerometer (linear acceleration including gravity) at high rates (e.g., 100-1000 Hz), optionally augmented with a magnetometer (Earth's magnetic field vectors) to provide absolute heading; the raw packets are time-stamped by a sensor hub or microcontroller, buffered in ring buffers via DMA, and accompanied by metadata (sampling frequency, calibration version, device ID, battery state, temperature) to facilitate quality assessment and downstream synchronization. Alternative motion sensors include optical sensors (e.g., monocular or stereo cameras, depth or time-of-flight sensors) that produce frames at 5-60 fps for visual odometry or pose estimation; gaze/eye-tracking sensors that report gaze vectors, pupil centers, or corneal reflection features at tens to hundreds of Hz; radio/location modalities (e.g., UWB angle/range, Bluetooth RSSI variations) that infer coarse movement or heading relative to anchors; and physiological sensors such as EMG on the neck/shoulders that capture intentional head gestures (nods, shakes) as motion proxies in constrained environments.

A sensor subsystem may fuse two or more modalities—IMU, camera, gaze, magnetometer, radio, using complementary filters, Mahony/Madgwick filters, extended Kalman filters, or learned fusion to output stable orientation states (quaternions, rotation matrices), and these fused states are considered motion data regardless of their sources. During reception, the device can apply factory and runtime calibration (bias and scale factor correction, axis alignment, gyro/accel cross-calibration, hard/soft-iron magnetometer compensation), denoising (low-pass/high-pass filtering, adaptive filters, outlier rejection), coordinate transforms (device-frame to head-frame or world-frame), and sampling conversion (downsample high-rate IMU streams to 5-30 Hz for alignment with audio/gaze/video, or upsample lower-rate vision outputs to match processing windows). To ensure consistent timing across modalities, clock drift can be corrected by correlating short audio windows or by using hardware timebases; timestamps and synchronization markers are stored alongside data.

The step supports multiple operating modes tuned to power, privacy, and responsiveness: continuous mode (sensors sample uninterrupted for active or noisy conversations), duty-cycled mode (low-rate sampling escalates to high-rate when motion thresholds or interrupts fire), event-driven mode (wake on IMU motion interrupt or magnetometer heading change and capture a burst window), and privacy-aware mode (cameras disabled while IMU/magnetometer maintain orientation). Error handling includes detecting sensor saturation, dropouts, or invalid packets and labeling segments with confidence flags; an example is switching to magnetometer-only yaw updates when gyroscope saturates during a sudden head turn, or temporarily discounting EMG signals during incidental neck strain.

The received motion data can take the form of raw timeseries (gyro/accel/mag vectors), derived states (quaternions, rotation matrices), spherical coordinates (azimuth/elevation per time step), or feature windows segmented for downstream processing (e.g., 30-second windows with angular velocity, angular acceleration, dwell time per sector, and trajectory statistics). In a seated meeting example, IMU sampling at 500 Hz with magnetometer yaw maintenance provides smooth azimuth/elevation traces while cameras remain off to preserve privacy; in a noisy café, continuous IMU plus optional low-bit-rate gaze vectors capture rapid head turns and dwell patterns without relying on audio localization; in a presentation, IMU+magnetometer+occasional camera frames enable brief visual re-anchoring for absolute yaw while maintaining low overall power. Across these scenarios, step 1010 yields stable, synchronized motion data, whether raw or fused, which is indicative of user head-orienting behavior and suitable for determining at least one auditory zone of interest in the subsequent processing stages.

Step 1020 involves determining, from the motion data, at least one auditory zone of interest within an acoustic scene, and is broadly defined to cover any algorithmic or heuristic process that maps user motion (e.g., head-orienting behavior) into one or more spatial regions likely to contain an audio source the user intends to focus on. In some embodiments, the motion data comprises orientation states (e.g., quaternions, rotation matrices, or spherical coordinates such as azimuth/elevation) computed from IMU signals; in multimodal embodiments, the motion data can also include gaze vectors, camera-derived head pose, or magnetometer heading used to stabilize yaw for world-locked operation.

The acoustic scene may be represented discretely by partitioning space into angular sectors (e.g., azimuth bins like [−100, −60], [−60, −30], [−30, 0], [0, −30], [30, 60], [60, 100]) or continuously by estimating a focus angle and mapping that angle to one or more sectors at render time. The determination may be executed over short-duration segments (e.g., 5, 10, or 30 seconds) to mitigate drift and to capture dwell patterns, micro-adjustments, and repeated returns to a region, which together indicate user intent. Preprocessing can include normalization of azimuth/elevation trajectories, removal of outliers during abrupt non-conversational motions, and extraction of temporal features such as angular velocity, acceleration, dwell time per sector, transition counts, and path statistics (e.g., mean, median, variance of orientation within a window).

There are multiple ways to perform the determination. A rule-based approach can cluster azimuth samples during the user's non-speaking state (e.g., via density-based spatial clustering like DBSCAN) and select the cluster centroid(s) as zones of interest; dwell thresholds (e.g., minimum time facing a sector) can be used to filter transient glances. A heuristic approach can compute a histogram over discretized azimuth bins and select bins with counts exceeding a threshold, optionally blending adjacent bins when counts are comparable (e.g., the user alternates attention between two closely seated talkers). A machine-learning approach can use a sequence model to classify zones directly: stacked 1D convolutions capture short-term patterns (rapid turns, micro-adjustments), followed by a temporal module such as a bidirectional LSTM, GRU, TCN, or transformer tuned for time-series to capture longer-range behavior like sector dwell and recurrent orientation; self-attention can highlight salient moments (e.g., sustained facing angle or peaks in angular velocity), and static context (e.g., estimated number of active talkers, auxiliary voice-activity indicators, conversational state) can be fused via concatenation or gating to sharpen the decision. The output may be a single sector (for one-to-one conversations) or a multilabel distribution across sectors (for multi-speaker scenes), enabling graded focus (e.g., 70% toward −30°, 30% toward −60° when two talkers compete). In continuous formulations, the model can regress a focus angle and a confidence score, then select the nearest sector(s) above a threshold; temporal smoothing (e.g., exponential/median filters) can prevent jitter and provide stable world-locked operation even when the user briefly looks away.

World-locking and frame references can be handled in several ways. If magnetometer or visual anchors are available, yaw can be stabilized so the zone of interest stays fixed in the environment independent of instantaneous head pose; otherwise, periodic re-anchoring (e.g., when stillness is detected) can realign azimuth zero to the current forward direction. Elevation may be used when vertical separation matters (e.g., seated vs. standing presenter), with sectors defined in 2D (azimuth×elevation) or with elevation used as a secondary discriminator. To address class imbalance in typical seated conversations (more frontal samples than extreme left/right), training can incorporate weighted objectives and imbalanced classifier heads (deeper nonlinearity for peripheral bins), while inference can apply confidence calibration (e.g., temperature scaling) to avoid over-favoring frontal sectors. Robustness strategies include short windows to limit drift, overlap-add segmentation for smooth updates, and fallback to coarse heading (e.g., magnetometer-only) if high-rate IMU is unavailable. Examples illustrate the breadth of this step: in a seated meeting, the system identifies a single left-front sector as the zone of interest based on sustained facing and dwell; in a noisy café, the system selects two adjacent far-left sectors with confidence weighting when two colleagues speak intermittently; during a presentation, elevation-aware sectors allow preferential focus on a standing presenter even if a nearby seated talker occasionally interjects. Across these variants, step 1020 yields a stable, intent-aware spatial region, one or more auditory zones of interest within the acoustic scene, derived from motion data and suitable for driving selective audio enhancement downstream.

Step 1030 involves capturing, via at least one audio transducer of a wearable device, audio signals of the acoustic scene, and is broadly defined to encompass any acquisition of sound pressure information representative of the surrounding environment, conversation partners, and other sound sources. In common embodiments, the wearable device includes a microphone array distributed on the frame (e.g., temples, bridge, underside), with individual microphones sampling at audio rates (e.g., 16-48 kHz) and quantization depths suitable for speech enhancement (e.g., 16-24 bit). Array geometries may include two to five microphones on smart glasses, bilateral microphones at each temple for binaural capture, or hybrid placements that balance wind robustness and target directivity. Alternative audio transducers include bone-conduction microphones placed on the mastoid or cartilage-conduction pickups near the tragus for robust own-voice sensing; wired or wireless earbuds can provide additional channels; external companion devices (e.g., neckbands) can host higher-count arrays and stream audio to the wearable.

Audio capture can be performed in multiple modes. In continuous mode, microphones sample uninterrupted to provide maximum context for beamforming and noise reduction. In duty-cycled mode, low-rate monitoring (e.g., VAD at sub-band level) escalates to full-band recording when activity is detected. In event-driven mode, hardware VAD or wake-on-sound triggers a short capture window (e.g., 1-5 seconds) that overlaps with motion windows to conserve power. Privacy-aware mode may suppress recording of local storage while still permitting real-time processing with no content retention; in camera-off contexts, audio capture remains the primary ambient sensing modality. For robustness, the system can apply wind-noise mitigation (e.g., acoustic mesh, mechanical shields, adaptive filtering), clip protection (automatic gain control, limiter), and per-mic health checks (self-noise monitoring, DC offset detection).

The captured signals may include near-field components (own-voice, breathing) and far-field components (conversation partners, ambient noise, media playback). Preprocessing can include pre-emphasis, DC offset removal, band-pass filtering (e.g., speech band 100 Hz-8 kHz), delay-and-sum alignment for array processing, and sample-rate conversion to a common rate used by downstream modules. Multi-channel audio can be segmented into short frames (e.g., 10-30 ms) and aggregated into windows (e.g., 0.5-2 s) with overlap to support time-frequency analysis. The system can compute spectral features (STFT, mel-filterbanks), spatial features (interaural time/level differences, generalized cross-correlation), and direction-of-arrival (DOA) cues, although the core invention does not require acoustic localization to establish the zone of interest because the zone is determined from motion data. When desired, acoustic features may serve as auxiliary context to refine separation or enhance rendering.

Step 1030 can exploit the previously determined auditory zone of interest to guide capture and preparation. For example, channel selection may prioritize microphones oriented toward the zone; beamformer steering vectors can be pre-configured to the sector corresponding to the zone; time-frequency masks can be initialized with priors biased toward sources arriving from the zone; or spatial post-filters can attenuate off-zone directions. In multi-speaker scenes with overlapping speech, the system can capture full-scene audio but mark frames coincident with the zone decision for prioritized processing. In a seated meeting, an endfire beamformer can emphasize a left-front sector; in a café, a binaural post-filter can improve SNR while preserving spatial cues; in a presentation, elevation-aware filters can suppress seated chatter while passing a standing presenter.

Capture also includes metadata essential for synchronization with motion data (step 1010) and zone determination (step 1020). Audio packets carry timestamps aligned to the device timebase; drift across sensors can be corrected via periodic correlation of short audio segments or hardware clock discipline. Confidence flags annotate frames affected by strong wind or occlusion; VAD marks speech activity at low bit-rate to inform adaptive processing; and scene descriptors (e.g., noise profile, reverb estimate) can be computed opportunistically. In lower-power designs, the device may capture only summary features (e.g., sub-band energy, coarse DOA) instead of raw waveforms and perform selective full-band recording when the zone of interest changes or speech activity exceeds a threshold.

Across these embodiments, step 1030 provides the audio signals of the acoustic scene, obtained by one or more microphones or equivalent transducers on or associated with the wearable device, prepared and synchronized to enable subsequent rendering to the user with selective enhancement of audio corresponding to the previously determined auditory zone of interest relative to other audio.

Step 1040 involves rendering audio to the user with selective enhancement of audio corresponding to the previously determined auditory zone of interest relative to other audio, and is broadly defined to encompass any processing and playback operation that increases the perceptual prominence, intelligibility, or spatial salience of sounds arriving from the zone while attenuating, separating, or de-emphasizing competing sounds. In typical embodiments, rendering is performed by at least one audio output device of the wearable system, such as bilateral air-conduction speakers positioned near the ears, bone-conduction transducers coupled to the mastoid, or cartilage-conduction transducers near the tragus; alternatives include streaming enhanced audio to paired earbuds, a neckband, or another companion device.

Selective enhancement can be realized through several complementary processing layers. Beamforming steers array response toward the auditory zone of interest using precomputed or adaptively updated steering vectors aligned with the selected sector; variants include endfire, delay-and-sum, MVDR, and neural beamformers. Target signal separation extracts speech components consistent with the zone's direction using time-frequency masking (e.g., Wiener/IRM), spatial filters (e.g., GCC-PHAT DOA priors), or learned source separation networks that accept motion-informed priors. Noise reduction suppresses diffuse and directional interferers outside the zone via single-channel or multi-channel spectral subtraction, Wiener filtering, supervised denoising, or deep noise suppressors; off-zone attenuation can be frequency-dependent to preserve natural ambience. Gain shaping and equalization emphasize speech-critical bands (e.g., 1-4 kHz), compensate for transducer response, and apply compression/limiting to maintain comfortable loudness over dynamic scenes. Spatialization preserves or synthesizes spatial cues (ITD/ILD, HRTF filtering) so the enhanced audio is perceived as originating from the selected zone, which aids talker tracking and listening comfort. In scenarios where user conversational state is known or inferred, rendering may adapt: own-voice suppression reduces self-speech feedback during speaking; listening-state profiles increase clarity and reduce fatigue; whisper-aware gain curves preserve intelligibility without harshness.

Render control operates continuously or at a cadence synchronized to the motion-decision windows (e.g., 5-30 s), updating enhancement direction as the zone of interest changes. To avoid perceptual artifacts, crossfades, hysteresis, or confidence-weighted blends can smooth transitions when adjacent zones are alternately selected (e.g., 70% focus on −30° and 30% on −60° during competing talkers). World-locked operation maintains enhancement toward a fixed environmental direction independent of instantaneous head pose; this can be achieved by stabilizing yaw via magnetometer or periodic visual re-anchoring and by mapping device-frame audio to a world-frame rendering reference so brief glance shifts do not break focus. In multi-zone scenarios (panel discussions), rendering can combine multiple beams with independent gains or use soft masks that bias enhancement to the highest-confidence sectors while retaining spatial context.

Some implementations incorporate robustness and user comfort measures. Automatic wind and handling noise mitigation reduces artifacts common to on-frame microphones; feedback management prevents howl-round in near-ear outputs; latency control keeps end-to-end delay within conversational comfort (e.g., <30-50 ms) by pipelining motion decision and audio processing; battery-aware profiles scale algorithm complexity (e.g., switch from neural beamformer to delay-and-sum) as power decreases; and privacy-aware settings constrain content retention, performing all rendering in real time without storing raw audio. Examples include a seated meeting where the device maintains focus on a left-front colleague despite brief glances to a laptop; a café where rendering biases enhancement to the two far-left sectors with confidence-weighted blending during overlap; and a presentation where elevation-aware spatialization passes a standing presenter while suppressing nearby seated chatter. Across these embodiments, step 1040 delivers intent-aware, zone-selective playback that increases intelligibility and listening ease by enhancing audio from the auditory zone of interest relative to other audio while preserving natural spatial awareness.

In some implementations, session-level aggregate predictions align with ground-truth distributions across sectors despite occasional segment-level mispredictions in closely spaced seating layouts. For example, a predicted sector may be “sandwiched” between two ground-truth sectors during a brief segment or exhibit slight undershooting, reflecting transient head movements and dwell transitions. Aggregating predictions over the session yields counts per sector that track ground-truth sector occupancy and can be used to stabilize rendering decisions across longer conversational durations while retaining short-window responsiveness for intent updates.

For a method in which the auditory zone of interest corresponds to a speaker of interest in a multi-speaker conversation and rendering selectively enhances speech from the speaker of interest relative to ambient noise, the acoustic scene can be understood as the totality of sounds present around the wearer, including speech, environmental sounds, and device-generated audio. In step 1020, the system determines the auditory zone of interest from motion data indicative of head-orienting behavior, selecting the spatial region most consistent with the wearer's intent to attend to a particular conversation partner. In step 1040, selective enhancement is applied to increase intelligibility of the target speech arriving from that zone while attenuating ambient noise from other directions or diffuse sources.

In practice, a wearer seated at a table with three colleagues may naturally orient toward one person while listening. The system identifies the zone of interest corresponding to that person's location and preferentially enhances speech components from that region using beamforming and target separation, while suppressing background café noise and intermittent speech from non-target talkers. Enhancement may include frequency-dependent gains favoring the 1-4 kHz band and spatialization that maintains the perceived direction of the talker, thereby providing a natural listening experience. When the wearer shifts attention to another colleague, the zone of interest updates and the selective enhancement follows, with crossfading and hysteresis to avoid abrupt changes. For the method in which determining the auditory zone of interest involves estimating head orientation from the motion data and classifying the motion data over a time window to predict a discrete spatial sector of the acoustic scene, head orientation refers to the direction in which the wearer's head is facing, expressed in spherical coordinates such as azimuth and elevation. In step 1010, head orientation is derived from motion sensor signals (e.g., IMU quaternions converted to rotation matrices and projected to azimuth/elevation), and in step 1020, the system classifies these trajectories over short windows (e.g., 5-30 seconds) to predict the sector(s) most consistent with the wearer's auditory interest.

Examples include a sequence model that summarizes azimuth/elevation over a 30-second segment, captures dwell time within sectors and micro-adjustments toward a talker, and outputs one or more discrete sector labels. The classification may be multilabel to accommodate situations where two adjacent sectors are jointly relevant, such as when two conversation partners are seated close together. Temporal smoothing can be applied to prevent jitter in the decision as the wearer glances briefly away. This approach is robust to transient movements and avoids the need for frame-by-frame localization.

For a method in which the discrete spatial sector involve one of a plurality of azimuth bins, the acoustic scene is partitioned in azimuth to create discrete regions around the wearer. Bins may be uniform or non-uniform, for example [−100, −60], [−60, −30], [−30, 0], [0, −30], [30, 60], and [60, 100], where negative angles denote rightward directions and positive angles denote leftward directions relative to the frontal axis.

In step 1020, classification outputs one or more of these bins as the auditory zone(s) of interest, which the system then uses in step 1040 to steer enhancement. In a panel discussion, this allows immediate selection of a left-front bin when the wearer attends to a speaker on that side, or a near-frontal bin when the wearer listens to a speaker directly ahead. Alternative discretizations may include elevation to differentiate seated and standing speakers, or dynamically adjusted bin widths to reflect scene density.

For a method in which determining the auditory zone of interest is performed over a short-duration time segment to mitigate sensor drift, short windows reduce error accumulation inherent to inertial sensors. In step 1010, motion data is received at high rates and may be downsampled for processing; in step 1020, segments of 5, 10, or 30 seconds are analyzed to capture stable head-orienting behavior while limiting the impact of drift. In a practical scenario, analyzing 30-second segments yields robust zone decisions aligned with conversational patterns such as sustained facing angles or recurrent returns to a region. Shorter windows (e.g., 5-10 seconds) improve responsiveness when the wearer rapidly shifts attention, and longer windows (e.g., 60 seconds) can smooth behavior but benefit from periodic recalibration (e.g., magnetometer heading updates). Overlap-add segmentation can be used to update decisions smoothly between windows.

For the method in which determining the auditory zone of interest involves processing the motion data with a machine-learning classifier, the system can employ sequence models that learn patterns in head movement indicative of auditory intent. In step 1010, motion data is received and preprocessed into features such as azimuth/elevation trajectories, angular velocity, acceleration, dwell time, and transition counts; in step 1020, these features are fed to a classifier such as a CNN-BiLSTM, GRU, TCN, or transformer to predict one or more sectors. Training may use cross-entropy loss for multilabel classification, with class weighting to address underrepresented bins (e.g., extreme left/right). Attention mechanisms can be applied to highlight salient intervals, such as sustained facing or peak turns. Auxiliary context like estimated number of talkers or voice-activity indicators can be fused to refine decisions. Alternative approaches include continuous angle regression followed by sector mapping at render time. For the method further comprising determining, from the motion data, a conversational state of the user as listening or speaking and adjusting the rendering based on the conversational state, conversational state refers to whether the wearer is actively speaking or passively listening. In step 1010, motion data can capture signatures characteristic of these states, such as increased variability and amplitude of head motion when speaking, and constrained, nodding or sustained facing when listening.

In step 1040, rendering adapts based on the state. When the wearer is speaking, own-voice suppression reduces amplification of the wearer's voice to prevent feedback and maintain comfort; when listening, clarity enhancement increases gain in speech-critical bands and applies stronger noise reduction. In a meeting, this enables the system to minimize distractions during the wearer's speaking moments and maximize intelligibility while listening. For the method wherein adjusting the rendering based on the conversational state involves activating own-voice suppression in the speaking state and increasing speech clarity enhancement in the listening state, own-voice suppression refers to attenuation of the wearer's voice at the output to avoid harshness or feedback. In step 1040, suppression may be applied selectively when motion-based state detection indicates speaking, using near-field microphones or bone-conduction signals to identify own voice.

Speech clarity enhancement in listening state can include gain shaping and equalization focused on intelligibility, compression to stabilize levels, and spatialization to preserve directional cues. In a lecture hall, when the wearer speaks into a microphone, own-voice suppression prevents excessive output levels; during the lecture, clarity enhancement improves comprehension of the presenter against ambient noise.

For a method involving beamforming the captured audio signals toward the auditory zone of interest and spatializing rendered audio corresponding to the auditory zone of interest relative to other audio, beamforming refers to steering an array's directional response toward the selected sector. In step 1030, a microphone array captures the acoustic scene; in step 1040, beamforming is applied to emphasize signals arriving from the auditory zone of interest, with variants such as delay-and-sum, endfire, MVDR, or neural beamforming.

Spatializing refers to preserving or synthesizing spatial cues (e.g., interaural time/level differences, HRTF filtering) so the enhanced audio is perceived as originating from the selected zone. In a café, beamforming improves signal-to-noise ratio for a far-left talker, while spatialization maintains the perception that the talker's voice is on the left, aiding talker tracking and reducing listener fatigue.

For a method involving capturing the audio signals involves acquiring ambient audio via a microphone array of the wearable device, ambient audio refers to the sounds present in the environment, including speech from conversation partners, background noise, and other sources. In step 1030, microphones distributed on the frame acquire ambient audio at suitable sampling rates and bit depths, providing channels for directional processing. Examples of array geometries include two microphones for basic directional cues, five microphones for improved beamforming and binaural capture, or hybrid arrangements optimizing wind robustness and target directivity. The array enables delay-and-sum alignment, computation of spatial features such as interaural differences, and application of beamformer steering vectors corresponding to the selected zone of interest.

For a method involving rendering via outputting audio via bilateral transducers of the wearable device, bilateral transducers refer to audio output devices positioned near each ear. In step 1040, enhanced audio is rendered to the wearer through air-conduction speakers, bone-conduction transducers, or cartilage-conduction devices, selected based on comfort, power, and privacy considerations.

In scenarios where paired earbuds or a neckband are preferred, the system can stream enhanced audio to those devices. Output processing includes gain shaping, equalization to compensate for transducer response, compression/limiting for comfortable loudness, and spatialization to maintain directional cues. Latency control ensures end-to-end delay is within conversational comfort, for example less than 30-50 milliseconds. For a method wherein the auditory zone of interest is maintained in a world-locked frame of reference independent of instantaneous head pose, world-locked refers to keeping the enhancement direction fixed relative to the environment even as the wearer moves. In step 1010, magnetometer heading or visual anchors can stabilize yaw; in step 1040, audio rendering maps device-frame signals to a world-frame reference.

In some examples, when the wearer briefly glances at a laptop, the enhancement continues to favor the left-front colleague rather than shifting with head pose. Periodic re-anchoring may reset the forward direction when the wearer remains still, and confidence-weighted blending can smooth transitions when adjacent zones alternate. World-locking aids conversational continuity and reduces the need for unnatural head-orienting behavior.

For a method where the motion sensor is an inertial measurement unit including at least one of a gyroscope, an accelerometer, or a magnetometer, an inertial measurement unit provides measurements of angular rate, linear acceleration, and magnetic field for absolute heading. In step 1010, high-rate sampling captures head movement; in step 1020, these signals are converted to orientation states used to determine the zone of interest. Examples include a 6-axis IMU (gyroscope and accelerometer) sufficient for head-pose estimation in seated conversations, and a 9-axis IMU (adding magnetometer) to stabilize yaw for world-locked operation. Calibration includes bias and scale factor correction, axis alignment, and hard/soft-iron compensation. Filtering includes complementary or Kalman filters, and fusion can incorporate occasional visual re-anchoring when cameras are enabled.

For a method where the motion sensor is a sensor subsystem configured to fuse motion data from at least two of an IMU, an eye-tracking sensor, and a camera, sensor fusion refers to combining signals from multiple modalities to output stable orientation or gaze states. In step 1010, the subsystem can fuse IMU quaternions with gaze vectors and camera-based head pose estimates using extended Kalman filters or learned fusion.

In low-light scenes, gaze and IMU may suffice, while in high-noise environments cameras can provide valuable context for re-anchoring. Fusion improves robustness when one modality is degraded. The fused states are considered motion data and are used in step 1020 to determine the zone of interest. This approach preserves privacy by allowing cameras to be disabled where necessary while still providing reliable operation via IMU and gaze. For the method further comprising detecting a predetermined gesture from the motion data and triggering an action in response to the predetermined gesture, predetermined gesture refers to known patterns of head motion such as nods or shakes. In step 1010, motion data captures these gestures; in step 1040 or a control module, actions such as accepting or declining calls, switching zones, or toggling enhancement profiles can be triggered.

Examples include a head nod to confirm a prompt without using voice or touch, a head shake to mute the output temporarily, or a double nod to cycle through conversation partners in a multi-speaker setting. Gesture detection is robust to incidental movements by applying thresholds and temporal constraints, and can include confidence flags to prevent unintended actions during rapid head turns.

For a method wherein the predetermined gesture involves at least one of a head nod or a head shake, a head nod can be characterized by repetitive up-and-down motion detected in accelerometer signals, while a head shake can be identified by left-right oscillation seen in gyroscope channels. In step 1010, these gestures are detected via feature extraction and temporal pattern recognition.

In one example, the wearer nods to select the current auditory zone of interest or shake to dismiss a notification, with the system confirming via audio cues. Gestures can be enabled or disabled based on user preference and context, with sensitivity adjusted to balance responsiveness and false positives. Integration with the rendering pipeline allows seamless interaction without interrupting conversation.

For a method involving collecting statistics on user speaking and listening behavior and updating parameters of determining the auditory zone of interest or rendering based on the collected statistics, statistics refer to non-content measures such as frequency and duration of speaking/listening states, dwell time distribution across sectors, and transition patterns. In step 1010, motion data supports state detection; in step 1020 and step 1040, these statistics inform parameter adaptation.

Examples include adjusting classifier thresholds based on the wearer's typical dwell times, biasing sector selection toward frequently attended regions, or tuning rendering profiles to the wearer's preferences (e.g., more aggressive noise reduction). Privacy-preserving techniques such as on-device aggregation or federated learning can be used to update models without exposing raw data. Over time, the system adapts to individual conversational styles and environmental contexts, improving accuracy and user comfort.

Embodiments of this disclosure provide a technical solution to a technical problem in conversation-focused audio on wearable devices: reliably directing enhancement toward a user's intended talker without resorting to continuous camera use or full-time acoustic localization, both of which are power intensive, privacy sensitive, and brittle in noisy, multi-speaker environments. By receiving motion data indicative of user motion (e.g., IMU-derived head orientation), determining from that motion data at least one auditory zone of interest within an acoustic scene, capturing ambient audio via on-device microphones, and rendering audio with selective enhancement of signals from the zone of interest relative to other signals, the system replaces front-biased, assumption-driven behavior with an intent-aware, world-locked pipeline.

Technically, the approach may address one or more of several longstanding issues. Short-window orientation extraction and drift-mitigating preprocessing yield stable azimuth/elevation traces suitable for real-time inference. Sequence models and attention mechanisms map head-orienting behavior to one or more discrete spatial sectors, overcoming the ambiguity of closely spaced talkers and transient motions by operating as a multilabel classifier over segments rather than as a frame-by-frame localizer. The resulting zone decisions drive beamforming, separation, noise reduction, gain shaping, and spatialization to enhance intelligibility while preserving spatial cues, with optional state-aware adjustments (e.g., own-voice suppression when speaking). In doing so, the embodiments reduce compute and power, maintain privacy by avoiding always-on vision and continuous content analysis, and improve robustness in overlapping speech and high-noise scenes, thereby delivering a concrete, engineered improvement to the functioning of wearable audio systems.

In some embodiments, this architecture was tested under multiple training and evaluation settings to validate robustness and feasibility for on-device execution. The proposed head-orientation-based localization network produces macro-F1 and Hamming scores that outperform rule-based, non-temporal, and transformer-based baselines in six-sector discretization, with further gains achievable when fusing static estimates of the number of conversation partners. The companion classification network achieves high accuracy in estimating conversational group size using IMU-only features, with additional improvements when adding low-bit-rate voice-activity streams or talkativeness-based target shaping. Across ablations, end-to-end stage-wise fusion of the learned static representation enables intent-aware enhancement without continuous camera operation or full-time acoustic localization, and thereby reduces power consumption while preserving privacy.

### EXAMPLE EMBODIMENTS

Clause 1. A computer-implemented method, the method comprising: receiving, by a motion sensor of a wearable device, motion data indicative of user motion; determining, from the motion data, an auditory zone of interest within an acoustic scene; capturing, via an audio transducer of the wearable device, audio signals of the acoustic scene; and rendering audio to the user with selective enhancement of at least one audio signal of the acoustic scene from the auditory zone of interest relative to other audio signals of the acoustic scene.
Clause 2. The method of clause 1, wherein the auditory zone of interest corresponds to a speaker of interest in a multi-speaker conversation and rendering selectively enhances speech from the speaker of interest relative to ambient noise.
Clause 3. The method of clause 1, wherein determining the auditory zone of interest comprises estimating head orientation from the motion data and classifying the motion data over a time window to predict a discrete spatial sector of the acoustic scene.
Clause 4. The method of clause 3, wherein the discrete spatial sector comprises one of a plurality of azimuth bins.
Clause 5. The method of clause 1, wherein determining the auditory zone of interest is performed over a short-duration time segment to mitigate sensor drift.
Clause 6. The method of clause 1, wherein determining the auditory zone of interest comprises processing the motion data with a machine-learning classifier.
Clause 7. The method of clause 1, further comprising determining, from the motion data, a conversational state of the user as listening or speaking and adjusting the rendering based on the conversational state.
Clause 8. The method of clause 7, wherein adjusting the rendering based on the conversational state comprises activating own-voice suppression in the speaking state and increasing speech clarity enhancement in the listening state.
Clause 9. The method of clause 1, further comprising beamforming the captured audio signals toward the auditory zone of interest and spatializing rendered audio corresponding to the auditory zone of interest relative to other audio.
Clause 10. The method of clause 1, wherein capturing the audio signals comprises acquiring ambient audio via a microphone array of the wearable device.
Clause 11. The method of clause 1, wherein rendering comprises outputting audio via bilateral transducers of the wearable device.
Clause 12. The method of clause 1, wherein the auditory zone of interest is maintained in a world-locked frame of reference independent of instantaneous head pose.
Clause 13. The method of clause 1, wherein the motion sensor comprises an inertial measurement unit (IMU) including at least one of a gyroscope, an accelerometer, or a magnetometer.
Clause 14. The method of clause 1, wherein the motion sensor comprises a sensor subsystem configured to fuse motion data from at least two of an IMU, an eye-tracking sensor, and a camera.
Clause 15. The method of clause 1, further comprising detecting a predetermined gesture from the motion data and triggering an action in response to the predetermined gesture.
Clause 16. The method of clause 15, wherein the predetermined gesture comprises at least one of a head nod or a head shake.
Clause 17. The method of clause 1, further comprising collecting statistics on user speaking and listening behavior and updating parameters of determining the auditory zone of interest or rendering based on the collected statistics.
Clause 18. A wearable device comprising: at least one physical processor; a motion sensor communicatively coupled the physical processor; an audio transducer communicatively coupled to the physical processor; and physical memory comprising computer-executable instructions that, when executed by the physical processor, cause the physical processor to: receive, by the motion sensor, motion data indicative of user motion; determine, from the motion data, an auditory zone of interest within an acoustic scene; capture, via the audio transducer of the wearable device, audio signals of the acoustic scene; and render audio to the user with selective enhancement of at least one audio signal of the acoustic scene from the auditory zone of interest relative to other audio signals of the acoustic scene.
Clause 19. The wearable device of clause 18, wherein the auditory zone of interest corresponds to a speaker of interest in a multi-speaker conversation and the computer-executable instructions cause the physical processor to render the audio by selectively enhancing speech from a speaker of interest relative to ambient noise.
Clause 20. A non-transitory computer-readable medium comprising one or more computer-executable instructions that, when executed by at least one processor of a computing device, cause the computing device to: receive, by a motion sensor of a wearable device, motion data indicative of user motion; determine, from the motion data, an auditory zone of interest within an acoustic scene; capture, via an audio transducer of the wearable device, audio signals of the acoustic scene; and render audio to the user with selective enhancement of at least one audio signal of the acoustic scene from the auditory zone of interest relative to other audio signals of the acoustic scene.

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed-or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

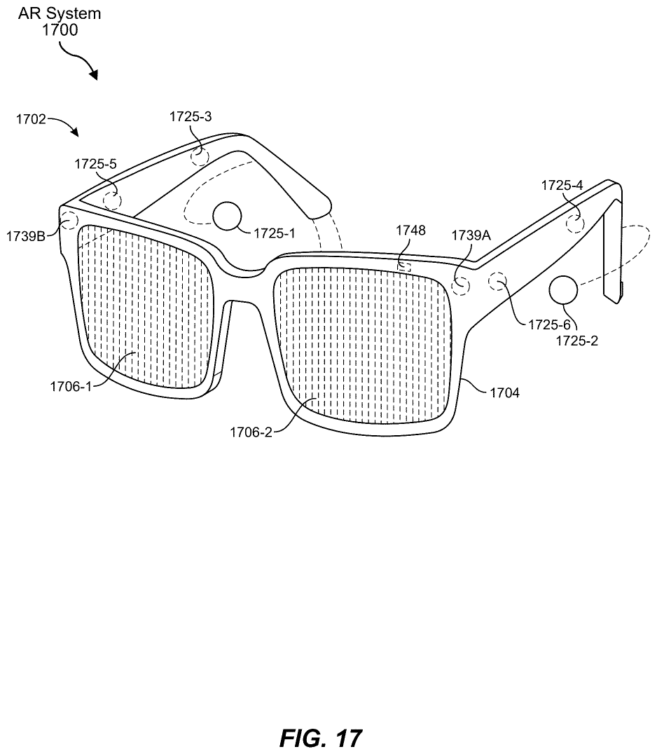

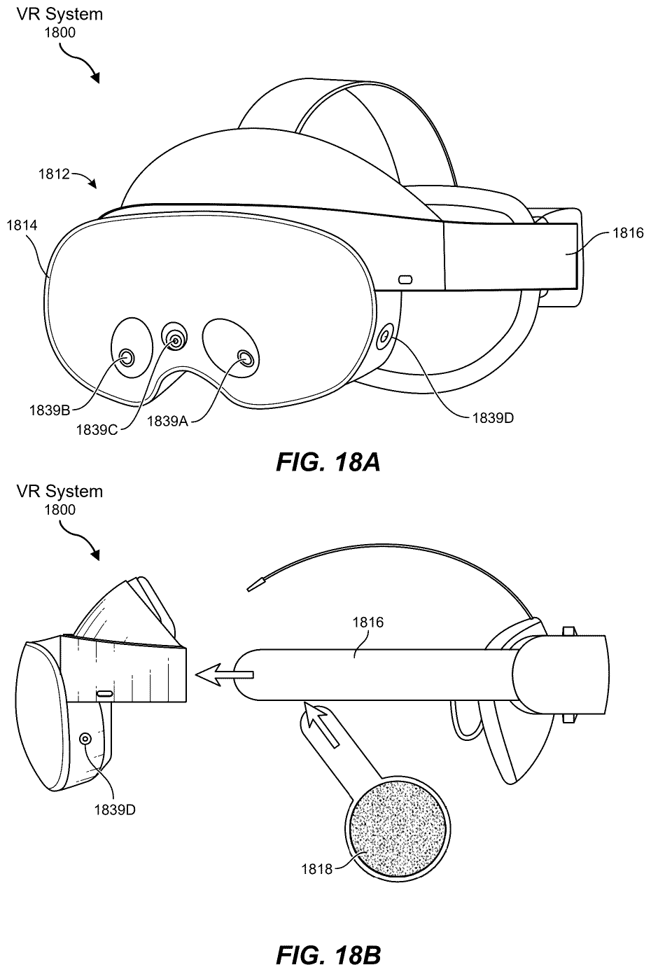

AR systems may be implemented in a variety of different form factors and configurations. Some AR systems may be designed to work without near-eye displays (NEDs). Other AR systems may include a NED that also provides visibility into the real world (such as, e.g., augmented-reality system 1700 in FIG. 17) or that visually immerses a user in an artificial reality (such as, e.g., virtual-reality system 1800 in FIGS. 18A and 18B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

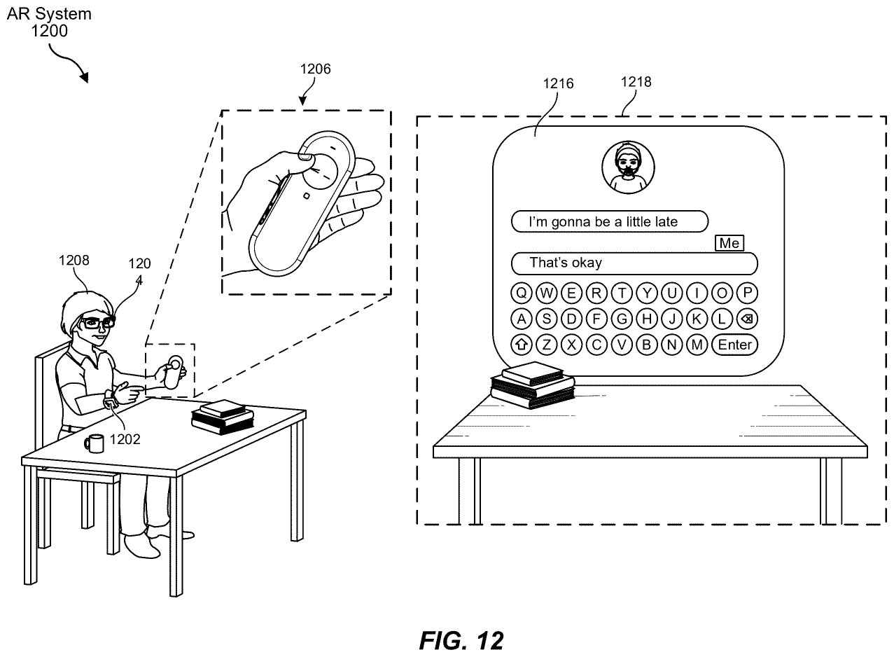

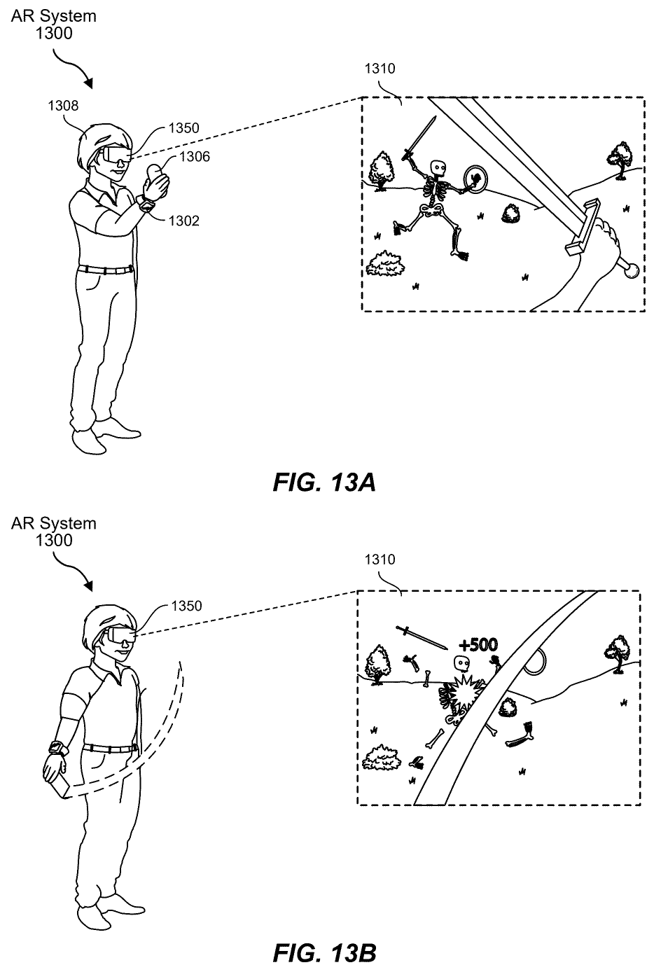

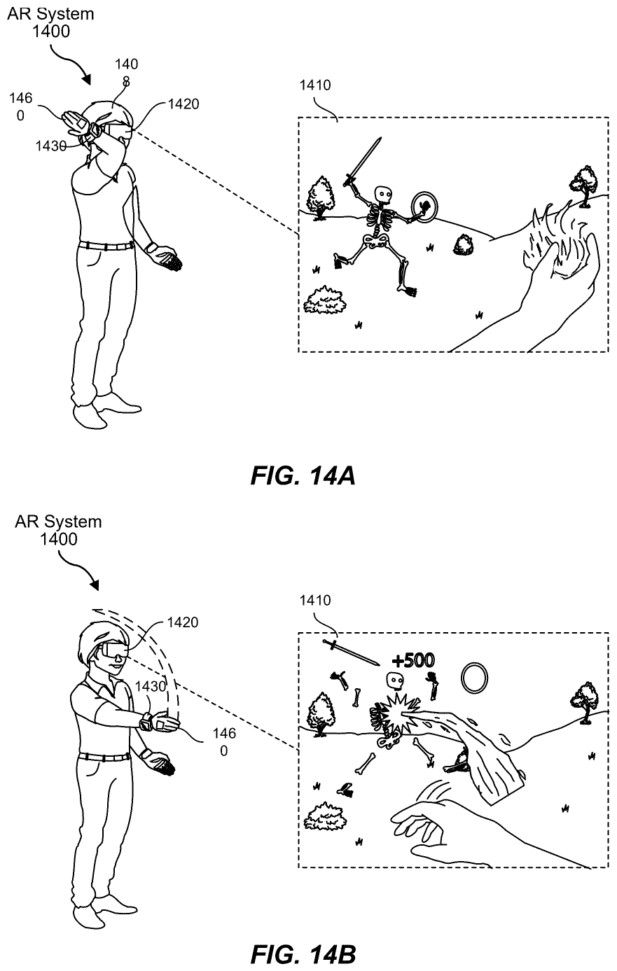

FIGS. 11-14B illustrate example artificial-reality (AR) systems in accordance with some embodiments. FIG. 11 shows a first AR system 1100 and first example user interactions using a wrist-wearable device 1102, a head-wearable device (e.g., AR glasses 1700), and/or a handheld intermediary processing device (HIPD) 1106. FIG. 12 shows a second AR system 1200 and second example user interactions using a wrist-wearable device 1202, AR glasses 1204, and/or an HIPD 1206. FIGS. 13A and 13B show a third AR system 1300 and third example user 1308 interactions using a wrist-wearable device 1302, a head-wearable device (e.g., VR headset 1350), and/or an HIPD 1306. FIGS. 14A and 14B show a fourth AR system 1400 and fourth example user 1408 interactions using a wrist-wearable device 1430, VR headset 1420, and/or a haptic device 1460 (e.g., wearable gloves).

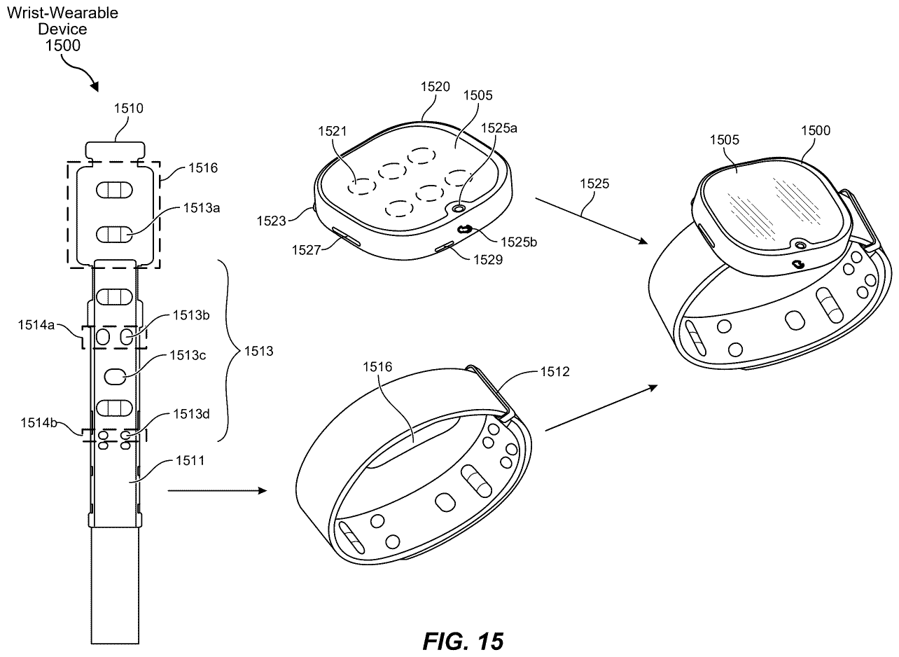

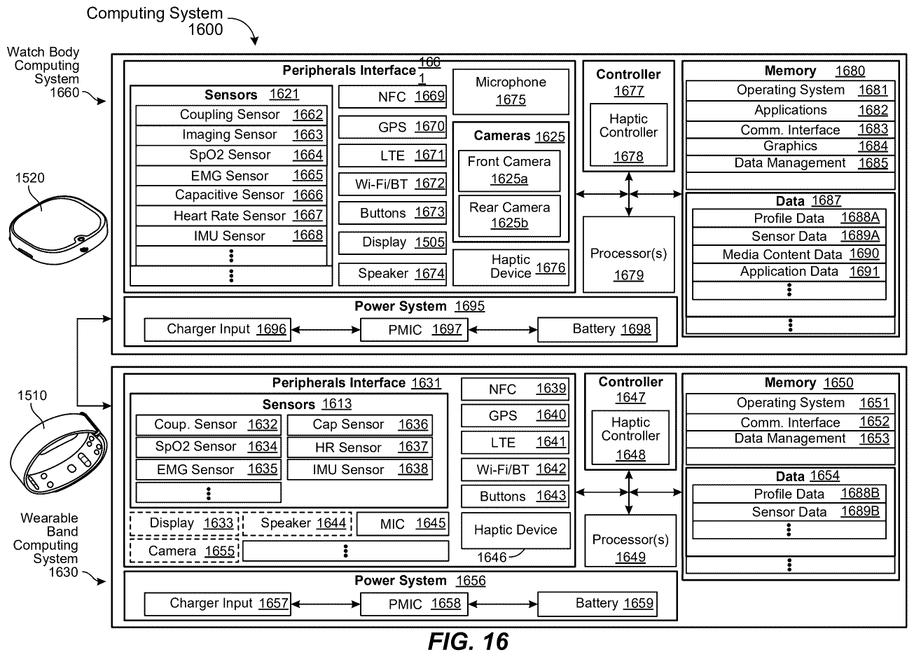

A wrist-wearable device 1500, which can be used for wrist-wearable device 1102, 1202, 1302, 1430, and one or more of its components, are described below in reference to FIGS. 15 and 16; head-wearable devices 1700 and 1800, which can respectively be used for AR glasses 1104, 1204 or VR headset 1350, 1420, and their one or more components are described below in reference to FIGS. 17-19.

Referring to FIG. 11, wrist-wearable device 1102, AR glasses 1104, and/or HIPD 1106 can communicatively couple via a network 1125 (e.g., cellular, near field, Wi-Fi, personal area network, wireless LAN, etc.). Additionally, wrist-wearable device 1102, AR glasses 1104, and/or HIPD 1106 can also communicatively couple with one or more servers 1130, computers 1140 (e.g., laptops, computers, etc.), mobile devices 1150 (e.g., smartphones, tablets, etc.), and/or other electronic devices via network 1125 (e.g., cellular, near field, Wi-Fi, personal area network, wireless LAN, etc.).

In FIG. 11, a user 1108 is shown wearing wrist-wearable device 1102 and AR glasses 1104 and having HIPD 1106 on their desk. The wrist-wearable device 1102, AR glasses 1104, and HIPD 1106 facilitate user interaction with an AR environment. In particular, as shown by first AR system 1100, wrist-wearable device 1102, AR glasses 1104, and/or HIPD 1106 cause presentation of one or more avatars 1110, digital representations of contacts 1112, and virtual objects 1114. As discussed below, user 1108 can interact with one or more avatars 1110, digital representations of contacts 1112, and virtual objects 1114 via wrist-wearable device 1102, AR glasses 1104, and/or HIPD 1106.

User 1108 can use any of wrist-wearable device 1102, AR glasses 1104, and/or HIPD 1106 to provide user inputs. For example, user 1108 can perform one or more hand gestures that are detected by wrist-wearable device 1102 (e.g., using one or more EMG sensors and/or IMUs, described below in reference to FIGS. 15 and 16) and/or AR glasses 1104 (e.g., using one or more image sensor or camera, described below in reference to FIGS. 17-10) to provide a user input. Alternatively, or additionally, user 1108 can provide a user input via one or more touch surfaces of wrist-wearable device 1102, AR glasses 1104, HIPD 1106, and/or voice commands captured by a microphone of wrist-wearable device 1102, AR glasses 1104, and/or HIPD 1106. In some embodiments, wrist-wearable device 1102, AR glasses 1104, and/or HIPD 1106 include a digital assistant to help user 1108 in providing a user input (e.g., completing a sequence of operations, suggesting different operations or commands, providing reminders, confirming a command, etc.). In some embodiments, user 1108 can provide a user input via one or more facial gestures and/or facial expressions. For example, cameras of wrist-wearable device 1102, AR glasses 1104, and/or HIPD 1106 can track eyes of user 1108 for navigating a user interface.

Wrist-wearable device 1102, AR glasses 1104, and/or HIPD 1106 can operate alone or in conjunction to allow user 1108 to interact with the AR environment. In some embodiments, HIPD 1106 is configured to operate as a central hub or control center for the wrist-wearable device 1102, AR glasses 1104, and/or another communicatively coupled device. For example, user 1108 can provide an input to interact with the AR environment at any of wrist-wearable device 1102, AR glasses 1104, and/or HIPD 1106, and HIPD 1106 can identify one or more back-end and front-end tasks to cause the performance of the requested interaction and distribute instructions to cause the performance of the one or more back-end and front-end tasks at wrist-wearable device 1102, AR glasses 1104, and/or HIPD 1106. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). As described below in reference to FIGS. Error! Reference source not found.-Error! Reference source not found., HIPD 1106 can perform the back-end tasks and provide wrist-wearable device 1102 and/or AR glasses 1104 operational data corresponding to the performed back-end tasks such that wrist-wearable device 1102 and/or AR glasses 1104 can perform the front-end tasks. In this way, HIPD 1106, which has more computational resources and greater thermal headroom than wrist-wearable device 1102 and/or AR glasses 1104, performs computationally intensive tasks and reduces the computer resource utilization and/or power usage of wrist-wearable device 1102 and/or AR glasses 1104.

In the example shown by first AR system 1100, HIPD 1106 identifies one or more back-end tasks and front-end tasks associated with a user request to initiate an AR video call with one or more other users (represented by avatar 1110 and the digital representation of contact 1112) and distributes instructions to cause the performance of the one or more back-end tasks and front-end tasks. In particular, HIPD 1106 performs back-end tasks for processing and/or rendering image data (and other data) associated with the AR video call and provides operational data associated with the performed back-end tasks to AR glasses 1104 such that the AR glasses 1104 perform front-end tasks for presenting the AR video call (e.g., presenting avatar 1110 and digital representation of contact 1112).

In some embodiments, HIPD 1106 can operate as a focal or anchor point for causing the presentation of information. This allows user 1108 to be generally aware of where information is presented. For example, as shown in first AR system 1100, avatar 1110 and the digital representation of contact 1112 are presented above HIPD 1106. In particular, HIPD 1106 and AR glasses 1104 operate in conjunction to determine a location for presenting avatar 1110 and the digital representation of contact 1112. In some embodiments, information can be presented a predetermined distance from HIPD 1106 (e.g., within 5 meters). For example, as shown in first AR system 1100, virtual object 1114 is presented on the desk some distance from HIPD 1106. Similar to the above example, HIPD 1106 and AR glasses 1104 can operate in conjunction to determine a location for presenting virtual object 1114. Alternatively, in some embodiments, presentation of information is not bound by HIPD 1106. More specifically, avatar 1110, digital representation of contact 1112, and virtual object 1114 do not have to be presented within a predetermined distance of HIPD 1106.

User inputs provided at wrist-wearable device 1102, AR glasses 1104, and/or HIPD 1106 are coordinated such that the user can use any device to initiate, continue, and/or complete an operation. For example, user 1108 can provide a user input to AR glasses 1104 to cause AR glasses 1104 to present virtual object 1114 and, while virtual object 1114 is presented by AR glasses 1104, user 1108 can provide one or more hand gestures via wrist-wearable device 1102 to interact and/or manipulate virtual object 1114.

FIG. 12 shows a user 1208 wearing a wrist-wearable device 1202 and AR glasses 1204, and holding an HIPD 1206. In second AR system 1200, the wrist-wearable device 1202, AR glasses 1204, and/or HIPD 1206 are used to receive and/or provide one or more messages to a contact of user 1208. In particular, wrist-wearable device 1202, AR glasses 1204, and/or HIPD 1206 detect and coordinate one or more user inputs to initiate a messaging application and prepare a response to a received message via the messaging application.

In some embodiments, user 1208 initiates, via a user input, an application on wrist-wearable device 1202, AR glasses 1204, and/or HIPD 1206 that causes the application to initiate on at least one device. For example, in second AR system 1200, user 1208 performs a hand gesture associated with a command for initiating a messaging application (represented by messaging user interface 1216), wrist-wearable device 1202 detects the hand gesture and, based on a determination that user 1208 is wearing AR glasses 1204, causes AR glasses 1204 to present a messaging user interface 1216 of the messaging application. AR glasses 1204 can present messaging user interface 1216 to user 1208 via its display (e.g., as shown by a field of view 1218 of user 1208). In some embodiments, the application is initiated and executed on the device (e.g., wrist-wearable device 1202, AR glasses 1204, and/or HIPD 1206) that detects the user input to initiate the application, and the device provides another device operational data to cause the presentation of the messaging application. For example, wrist-wearable device 1202 can detect the user input to initiate a messaging application, initiate and run the messaging application, and provide operational data to AR glasses 1204 and/or HIPD 1206 to cause presentation of the messaging application. Alternatively, the application can be initiated and executed at a device other than the device that detected the user input. For example, wrist-wearable device 1202 can detect the hand gesture associated with initiating the messaging application and cause HIPD 1206 to run the messaging application and coordinate the presentation of the messaging application.

Further, user 1208 can provide a user input provided at wrist-wearable device 1202, AR glasses 1204, and/or HIPD 1206 to continue and/or complete an operation initiated at another device. For example, after initiating the messaging application via wrist-wearable device 1202 and while AR glasses 1204 present messaging user interface 1216, user 1208 can provide an input at HIPD 1206 to prepare a response (e.g., shown by the swipe gesture performed on HIPD 1206). Gestures performed by user 1208 on HIPD 1206 can be provided and/or displayed on another device. For example, a swipe gestured performed on HIPD 1206 is displayed on a virtual keyboard of messaging user interface 1216 displayed by AR glasses 1204.

In some embodiments, wrist-wearable device 1202, AR glasses 1204, HIPD 1206, and/or any other communicatively coupled device can present one or more notifications to user 1208. The notification can be an indication of a new message, an incoming call, an application update, a status update, etc. User 1208 can select the notification via wrist-wearable device 1202, AR glasses 1204, and/or HIPD 1206 and can cause presentation of an application or operation associated with the notification on at least one device. For example, user 1208 can receive a notification that a message was received at wrist-wearable device 1202, AR glasses 1204, HIPD 1206, and/or any other communicatively coupled device and can then provide a user input at wrist-wearable device 1202, AR glasses 1204, and/or HIPD 1206 to review the notification, and the device detecting the user input can cause an application associated with the notification to be initiated and/or presented at wrist-wearable device 1202, AR glasses 1204, and/or HIPD 1206.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 1204 can present to user 1208 game application data, and HIPD 1206 can be used as a controller to provide inputs to the game. Similarly, user 1208 can use wrist-wearable device 1202 to initiate a camera of AR glasses 1204, and user 1208 can use wrist-wearable device 1202, AR glasses 1204, and/or HIPD 1206 to manipulate the image capture (e.g., zoom in or out, apply filters, etc.) and capture image data.

Users may interact with the devices disclosed herein in a variety of ways. For example, as shown in FIGS. 13A and 13B, a user 1308 may interact with an AR system 1300 by donning a VR headset 1350 while holding HIPD 1306 and wearing wrist-wearable device 1302. In this example, AR system 1300 may enable a user to interact with a game 1310 by swiping their arm. One or more of VR headset 1350, HIPD 1306, and wrist-wearable device 1302 may detect this gesture and, in response, may display a sword strike in game 1310. Similarly, in FIGS. 14A and 14B, a user 1408 may interact with an AR system 1400 by donning a VR headset 1420 while wearing haptic device 1460 and wrist-wearable device 1430. In this example, AR system 1400 may enable a user to interact with a game 1410 by swiping their arm. One or more of VR headset 1420, haptic device 1460, and wrist-wearable device 1430 may detect this gesture and, in response, may display a spell being cast in game 1310.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiography (ECG or EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configure to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 1702.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 15 and 16 illustrate an example wrist-wearable device 1500 and an example computer system 1600, in accordance with some embodiments. Wrist-wearable device 1500 is an instance of wearable device 1102 described in FIG. 11 herein, such that the wearable device 1102 should be understood to have the features of the wrist-wearable device 1500 and vice versa. FIG. 16 illustrates components of the wrist-wearable device 1500, which can be used individually or in combination, including combinations that include other electronic devices and/or electronic components.

FIG. 15 shows a wearable band 1510 and a watch body 1520 (or capsule) being coupled, as discussed below, to form wrist-wearable device 1500. Wrist-wearable device 1500 can perform various functions and/or operations associated with navigating through user interfaces and selectively opening applications as well as the functions and/or operations described above with reference to FIGS. 11-14B.

As will be described in more detail below, operations executed by wrist-wearable device 1500 can include (i) presenting content to a user (e.g., displaying visual content via a display 1505), (ii) detecting (e.g., sensing) user input (e.g., sensing a touch on peripheral button 1523 and/or at a touch screen of the display 1505, a hand gesture detected by sensors (e.g., biopotential sensors)), (iii) sensing biometric data (e.g., neuromuscular signals, heart rate, temperature, sleep, etc.) via one or more sensors 1513, messaging (e.g., text, speech, video, etc.); image capture via one or more imaging devices or cameras 1525, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 1520, independently in wearable band 1510, and/or via an electronic communication between watch body 1520 and wearable band 1510. In some embodiments, functions can be executed on wrist-wearable device 1500 while an AR environment is being presented (e.g., via one of AR systems 1100 to 1400). The wearable devices described herein can also be used with other types of AR environments.

Wearable band 1510 can be configured to be worn by a user such that an inner surface of a wearable structure 1511 of wearable band 1510 is in contact with the user's skin. In this example, when worn by a user, sensors 1513 may contact the user's skin. In some examples, one or more of sensors 1513 can sense biometric data such as a user's heart rate, a saturated oxygen level, temperature, sweat level, neuromuscular signals, or a combination thereof. One or more of sensors 1513 can also sense data about a user's environment including a user's motion, altitude, location, orientation, gait, acceleration, position, or a combination thereof. In some embodiment, one or more of sensors 1513 can be configured to track a position and/or motion of wearable band 1510. One or more of sensors 1513 can include any of the sensors defined above and/or discussed below with respect to FIG. 15.

One or more of sensors 1513 can be distributed on an inside and/or an outside surface of wearable band 1510. In some embodiments, one or more of sensors 1513 are uniformly spaced along wearable band 1510. Alternatively, in some embodiments, one or more of sensors 1513 are positioned at distinct points along wearable band 1510. As shown in FIG. 15, one or more of sensors 1513 can be the same or distinct. For example, in some embodiments, one or more of sensors 1513 can be shaped as a pill (e.g., sensor 1513a), an oval, a circle a square, an oblong (e.g., sensor 1513c) and/or any other shape that maintains contact with the user's skin (e.g., such that neuromuscular signal and/or other biometric data can be accurately measured at the user's skin). In some embodiments, one or more sensors of 1513 are aligned to form pairs of sensors (e.g., for sensing neuromuscular signals based on differential sensing within each respective sensor). For example, sensor 1513b may be aligned with an adjacent sensor to form sensor pair 1514a and sensor 1513d may be aligned with an adjacent sensor to form sensor pair 1514b. In some embodiments, wearable band 1510 does not have a sensor pair. Alternatively, in some embodiments, wearable band 1510 has a predetermined number of sensor pairs (one pair of sensors, three pairs of sensors, four pairs of sensors, six pairs of sensors, sixteen pairs of sensors, etc.).

Wearable band 1510 can include any suitable number of sensors 1513. In some embodiments, the number and arrangement of sensors 1513 depends on the particular application for which wearable band 1510 is used. For instance, wearable band 1510 can be configured as an armband, wristband, or chest-band that include a plurality of sensors 1513 with different number of sensors 1513, a variety of types of individual sensors with the plurality of sensors 1513, and different arrangements for each use case, such as medical use cases as compared to gaming or general day-to-day use cases.

In accordance with some embodiments, wearable band 1510 further includes an electrical ground electrode and a shielding electrode. The electrical ground and shielding electrodes, like the sensors 1513, can be distributed on the inside surface of the wearable band 1510 such that they contact a portion of the user's skin. For example, the electrical ground and shielding electrodes can be at an inside surface of a coupling mechanism 1516 or an inside surface of a wearable structure 1511. The electrical ground and shielding electrodes can be formed and/or use the same components as sensors 1513. In some embodiments, wearable band 1510 includes more than one electrical ground electrode and more than one shielding electrode.

Sensors 1513 can be formed as part of wearable structure 1511 of wearable band 1510. In some embodiments, sensors 1513 are flush or substantially flush with wearable structure 1511 such that they do not extend beyond the surface of wearable structure 1511. While flush with wearable structure 1511, sensors 1513 are still configured to contact the user's skin (e.g., via a skin-contacting surface). Alternatively, in some embodiments, sensors 1513 extend beyond wearable structure 1511 a predetermined distance (e.g., 0.1-2 mm) to make contact and depress into the user's skin. In some embodiment, sensors 1513 are coupled to an actuator (not shown) configured to adjust an extension height (e.g., a distance from the surface of wearable structure 1511) of sensors 1513 such that sensors 1513 make contact and depress into the user's skin. In some embodiments, the actuators adjust the extension height between 0.01 mm-1.2 mm. This may allow a the user to customize the positioning of sensors 1513 to improve the overall comfort of the wearable band 1510 when worn while still allowing sensors 1513 to contact the user's skin. In some embodiments, sensors 1513 are indistinguishable from wearable structure 1511 when worn by the user.

Wearable structure 1511 can be formed of an elastic material, elastomers, etc., configured to be stretched and fitted to be worn by the user. In some embodiments, wearable structure 1511 is a textile or woven fabric. As described above, sensors 1513 can be formed as part of a wearable structure 1511. For example, sensors 1513 can be molded into the wearable structure 1511, be integrated into a woven fabric (e.g., sensors 1513 can be sewn into the fabric and mimic the pliability of fabric and can and/or be constructed from a series woven strands of fabric).

Wearable structure 1511 can include flexible electronic connectors that interconnect sensors 1513, the electronic circuitry, and/or other electronic components (described below in reference to FIG. 16) that are enclosed in wearable band 1510. In some embodiments, the flexible electronic connectors are configured to interconnect sensors 1513, the electronic circuitry, and/or other electronic components of wearable band 1510 with respective sensors and/or other electronic components of another electronic device (e.g., watch body 1520). The flexible electronic connectors are configured to move with wearable structure 1511 such that the user adjustment to wearable structure 1511 (e.g., resizing, pulling, folding, etc.) does not stress or strain the electrical coupling of components of wearable band 1510.

As described above, wearable band 1510 is configured to be worn by a user. In particular, wearable band 1510 can be shaped or otherwise manipulated to be worn by a user. For example, wearable band 1510 can be shaped to have a substantially circular shape such that it can be configured to be worn on the user's lower arm or wrist. Alternatively, wearable band 1510 can be shaped to be worn on another body part of the user, such as the user's upper arm (e.g., around a bicep), forearm, chest, legs, etc. Wearable band 1510 can include a retaining mechanism 1512 (e.g., a buckle, a hook and loop fastener, etc.) for securing wearable band 1510 to the user's wrist or other body part. While wearable band 1510 is worn by the user, sensors 1513 sense data (referred to as sensor data) from the user's skin. In some examples, sensors 1513 of wearable band 1510 obtain (e.g., sense and record) neuromuscular signals.

The sensed data (e.g., sensed neuromuscular signals) can be used to detect and/or determine the user's intention to perform certain motor actions. In some examples, sensors 1513 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 1505 of wrist-wearable device 1500 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 1513 can be used to provide a user with an enhanced interaction with a physical object (e.g., devices communicatively coupled with wearable band 1510) and/or a virtual object in an artificial-reality application generated by an artificial-reality system (e.g., user interface objects presented on the display 1505, or another computing device (e.g., a smartphone)).

In some embodiments, wearable band 1510 includes one or more haptic devices 1646 (e.g., a vibratory haptic actuator) that are configured to provide haptic feedback (e.g., a cutaneous and/or kinesthetic sensation, etc.) to the user's skin. Sensors 1513 and/or haptic devices 1646 (shown in FIG. 16) can be configured to operate in conjunction with multiple applications including, without limitation, health monitoring, social media, games, and artificial reality (e.g., the applications associated with artificial reality).

Wearable band 1510 can also include coupling mechanism 1516 for detachably coupling a capsule (e.g., a computing unit) or watch body 1520 (via a coupling surface of the watch body 1520) to wearable band 1510. For example, a cradle or a shape of coupling mechanism 1516 can correspond to shape of watch body 1520 of wrist-wearable device 1500. In particular, coupling mechanism 1516 can be configured to receive a coupling surface proximate to the bottom side of watch body 1520 (e.g., a side opposite to a front side of watch body 1520 where display 1505 is located), such that a user can push watch body 1520 downward into coupling mechanism 1516 to attach watch body 1520 to coupling mechanism 1516. In some embodiments, coupling mechanism 1516 can be configured to receive a top side of the watch body 1520 (e.g., a side proximate to the front side of watch body 1520 where display 1505 is located) that is pushed upward into the cradle, as opposed to being pushed downward into coupling mechanism 1516. In some embodiments, coupling mechanism 1516 is an integrated component of wearable band 1510 such that wearable band 1510 and coupling mechanism 1516 are a single unitary structure. In some embodiments, coupling mechanism 1516 is a type of frame or shell that allows watch body 1520 coupling surface to be retained within or on wearable band 1510 coupling mechanism 1516 (e.g., a cradle, a tracker band, a support base, a clasp, etc.).

Coupling mechanism 1516 can allow for watch body 1520 to be detachably coupled to the wearable band 1510 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 1520 to wearable band 1510 and to decouple the watch body 1520 from the wearable band 1510. For example, a user can twist, slide, turn, push, pull, or rotate watch body 1520 relative to wearable band 1510, or a combination thereof, to attach watch body 1520 to wearable band 1510 and to detach watch body 1520 from wearable band 1510. Alternatively, as discussed below, in some embodiments, the watch body 1520 can be decoupled from the wearable band 1510 by actuation of a release mechanism 1529.

Wearable band 1510 can be coupled with watch body 1520 to increase the functionality of wearable band 1510 (e.g., converting wearable band 1510 into wrist-wearable device 1500, adding an additional computing unit and/or battery to increase computational resources and/or a battery life of wearable band 1510, adding additional sensors to improve sensed data, etc.). As described above, wearable band 1510 and coupling mechanism 1516 are configured to operate independently (e.g., execute functions independently) from watch body 1520. For example, coupling mechanism 1516 can include one or more sensors 1513 that contact a user's skin when wearable band 1510 is worn by the user, with or without watch body 1520 and can provide sensor data for determining control commands.

A user can detach watch body 1520 from wearable band 1510 to reduce the encumbrance of wrist-wearable device 1500 to the user. For embodiments in which watch body 1520 is removable, watch body 1520 can be referred to as a removable structure, such that in these embodiments wrist-wearable device 1500 includes a wearable portion (e.g., wearable band 1510) and a removable structure (e.g., watch body 1520).

Turning to watch body 1520, in some examples watch body 1520 can have a substantially rectangular or circular shape. Watch body 1520 is configured to be worn by the user on their wrist or on another body part. More specifically, watch body 1520 is sized to be easily carried by the user, attached on a portion of the user's clothing, and/or coupled to wearable band 1510 (forming the wrist-wearable device 1500). As described above, watch body 1520 can have a shape corresponding to coupling mechanism 1516 of wearable band 1510. In some embodiments, watch body 1520 includes a single release mechanism 1529 or multiple release mechanisms (e.g., two release mechanisms 1529 positioned on opposing sides of watch body 1520, such as spring-loaded buttons) for decoupling watch body 1520 from wearable band 1510. Release mechanism 1529 can include, without limitation, a button, a knob, a plunger, a handle, a lever, a fastener, a clasp, a dial, a latch, or a combination thereof.

A user can actuate release mechanism 1529 by pushing, turning, lifting, depressing, shifting, or performing other actions on release mechanism 1529. Actuation of release mechanism 1529 can release (e.g., decouple) watch body 1520 from coupling mechanism 1516 of wearable band 1510, allowing the user to use watch body 1520 independently from wearable band 1510 and vice versa. For example, decoupling watch body 1520 from wearable band 1510 can allow a user to capture images using rear-facing camera 1525b. Although release mechanism 1529 is shown positioned at a corner of watch body 1520, release mechanism 1529 can be positioned anywhere on watch body 1520 that is convenient for the user to actuate. In addition, in some embodiments, wearable band 1510 can also include a respective release mechanism for decoupling watch body 1520 from coupling mechanism 1516. In some embodiments, release mechanism 1529 is optional and watch body 1520 can be decoupled from coupling mechanism 1516 as described above (e.g., via twisting, rotating, etc.).

Watch body 1520 can include one or more peripheral buttons 1523 and 1527 for performing various operations at watch body 1520. For example, peripheral buttons 1523 and 1527 can be used to turn on or wake (e.g., transition from a sleep state to an active state) display 1505, unlock watch body 1520, increase or decrease a volume, increase or decrease a brightness, interact with one or more applications, interact with one or more user interfaces, etc. Additionally or alternatively, in some embodiments, display 1505 operates as a touch screen and allows the user to provide one or more inputs for interacting with watch body 1520.

In some embodiments, watch body 1520 includes one or more sensors 1521. Sensors 1521 of watch body 1520 can be the same or distinct from sensors 1513 of wearable band 1510. Sensors 1521 of watch body 1520 can be distributed on an inside and/or an outside surface of watch body 1520. In some embodiments, sensors 1521 are configured to contact a user's skin when watch body 1520 is worn by the user. For example, sensors 1521 can be placed on the bottom side of watch body 1520 and coupling mechanism 1516 can be a cradle with an opening that allows the bottom side of watch body 1520 to directly contact the user's skin. Alternatively, in some embodiments, watch body 1520 does not include sensors that are configured to contact the user's skin (e.g., including sensors internal and/or external to the watch body 1520 that are configured to sense data of watch body 1520 and the surrounding environment). In some embodiments, sensors 1521 are configured to track a position and/or motion of watch body 1520.

Watch body 1520 and wearable band 1510 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 1520 and wearable band 1510 can share data sensed by sensors 1513 and 1521, as well as application and device specific information (e.g., active and/or available applications, output devices (e.g., displays, speakers, etc.), input devices (e.g., touch screens, microphones, imaging sensors, etc.).

In some embodiments, watch body 1520 can include, without limitation, a front-facing camera 1525a and/or a rear-facing camera 1525b, sensors 1521 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 1663), a touch sensor, a sweat sensor, etc.). In some embodiments, watch body 1520 can include one or more haptic devices 1676 (e.g., a vibratory haptic actuator) that is configured to provide haptic feedback (e.g., a cutaneous and/or kinesthetic sensation, etc.) to the user. Sensors 1621 and/or haptic device 1676 can also be configured to operate in conjunction with multiple applications including, without limitation, health monitoring applications, social media applications, game applications, and artificial reality applications (e.g., the applications associated with artificial reality).

As described above, watch body 1520 and wearable band 1510, when coupled, can form wrist-wearable device 1500. When coupled, watch body 1520 and wearable band 1510 may operate as a single device to execute functions (operations, detections, communications, etc.) described herein. In some embodiments, each device may be provided with particular instructions for performing the one or more operations of wrist-wearable device 1500. For example, in accordance with a determination that watch body 1520 does not include neuromuscular signal sensors, wearable band 1510 can include alternative instructions for performing associated instructions (e.g., providing sensed neuromuscular signal data to watch body 1520 via a different electronic device). Operations of wrist-wearable device 1500 can be performed by watch body 1520 alone or in conjunction with wearable band 1510 (e.g., via respective processors and/or hardware components) and vice versa. In some embodiments, operations of wrist-wearable device 1500, watch body 1520, and/or wearable band 1510 can be performed in conjunction with one or more processors and/or hardware components.

As described below with reference to the block diagram of FIG. 16, wearable band 1510 and/or watch body 1520 can each include independent resources required to independently execute functions. For example, wearable band 1510 and/or watch body 1520 can each include a power source (e.g., a battery), a memory, data storage, a processor (e.g., a central processing unit (CPU)), communications, a light source, and/or input/output devices.

FIG. 16 shows block diagrams of a computing system 1630 corresponding to wearable band 1510 and a computing system 1660 corresponding to watch body 1520 according to some embodiments. Computing system 1600 of wrist-wearable device 1500 may include a combination of components of wearable band computing system 1630 and watch body computing system 1660, in accordance with some embodiments.

Watch body 1520 and/or wearable band 1510 can include one or more components shown in watch body computing system 1660. In some embodiments, a single integrated circuit may include all or a substantial portion of the components of watch body computing system 1660 included in a single integrated circuit. Alternatively, in some embodiments, components of the watch body computing system 1660 may be included in a plurality of integrated circuits that are communicatively coupled. In some embodiments, watch body computing system 1660 may be configured to couple (e.g., via a wired or wireless connection) with wearable band computing system 1630, which may allow the computing systems to share components, distribute tasks, and/or perform other operations described herein (individually or as a single device).

Watch body computing system 1660 can include one or more processors 1679, a controller 1677, a peripherals interface 1661, a power system 1695, and memory (e.g., a memory 1680).

Power system 1695 can include a charger input 1696, a power-management integrated circuit (PMIC) 1697, and a battery 1698. In some embodiments, a watch body 1520 and a wearable band 1510 can have respective batteries (e.g., battery 1698 and 1659) and can share power with each other. Watch body 1520 and wearable band 1510 can receive a charge using a variety of techniques. In some embodiments, watch body 1520 and wearable band 1510 can use a wired charging assembly (e.g., power cords) to receive the charge. Alternatively, or in addition, watch body 1520 and/or wearable band 1510 can be configured for wireless charging. For example, a portable charging device can be designed to mate with a portion of watch body 1520 and/or wearable band 1510 and wirelessly deliver usable power to battery 1698 of watch body 1520 and/or battery 1659 of wearable band 1510. Watch body 1520 and wearable band 1510 can have independent power systems (e.g., power system 1695 and 1656, respectively) to enable each to operate independently. Watch body 1520 and wearable band 1510 can also share power (e.g., one can charge the other) via respective PMICs (e.g., PMICs 1697 and 1658) and charger inputs (e.g., 1657 and 1696) that can share power over power and ground conductors and/or over wireless charging antennas.

In some embodiments, peripherals interface 1661 can include one or more sensors 1621. Sensors 1621 can include one or more coupling sensors 1662 for detecting when watch body 1520 is coupled with another electronic device (e.g., a wearable band 1510). Sensors 1621 can include one or more imaging sensors 1663 (e.g., one or more of cameras 1625, and/or separate imaging sensors 1663 (e.g., thermal-imaging sensors)). In some embodiments, sensors 1621 can include one or more SpO2 sensors 1664. In some embodiments, sensors 1621 can include one or more biopotential-signal sensors (e.g., EMG sensors 1665, which may be disposed on an interior, user-facing portion of watch body 1520 and/or wearable band 1510). In some embodiments, sensors 1621 may include one or more capacitive sensors 1666. In some embodiments, sensors 1621 may include one or more heart rate sensors 1667. In some embodiments, sensors 1621 may include one or more IMU sensors 1668. In some embodiments, one or more IMU sensors 1668 can be configured to detect movement of a user's hand or other location where watch body 1520 is placed or held.

In some embodiments, one or more of sensors 1621 may provide an example human-machine interface. For example, a set of neuromuscular sensors, such as EMG sensors 1665, may be arranged circumferentially around wearable band 1510 with an interior surface of EMG sensors 1665 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 1510 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 1679. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 1665 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 1661 includes a near-field communication (NFC) component 1669, a global-position system (GPS) component 1670, a long-term evolution (LTE) component 1671, and/or a Wi-Fi and/or Bluetooth communication component 1672. In some embodiments, peripherals interface 1661 includes one or more buttons 1673 (e.g., peripheral buttons 1523 and 1527 in FIG. 15), which, when selected by a user, cause operation to be performed at watch body 1520. In some embodiments, the peripherals interface 1661 includes one or more indicators, such as a light emitting diode (LED), to provide a user with visual indicators (e.g., message received, low battery, active microphone and/or camera, etc.).

Watch body 1520 can include at least one display 1505 for displaying visual representations of information or data to a user, including user-interface elements and/or three-dimensional virtual objects. The display can also include a touch screen for inputting user inputs, such as touch gestures, swipe gestures, and the like. Watch body 1520 can include at least one speaker 1674 and at least one microphone 1675 for providing audio signals to the user and receiving audio input from the user. The user can provide user inputs through microphone 1675 and can also receive audio output from speaker 1674 as part of a haptic event provided by haptic controller 1678. Watch body 1520 can include at least one camera 1625, including a front camera 1625a and a rear camera 1625b. Cameras 1625 can include ultra-wide-angle cameras, wide angle cameras, fish-eye cameras, spherical cameras, telephoto cameras, depth-sensing cameras, or other types of cameras.

Watch body computing system 1660 can include one or more haptic controllers 1678 and associated componentry (e.g., haptic devices 1676) for providing haptic events at watch body 1520 (e.g., a vibrating sensation or audio output in response to an event at the watch body 1520). Haptic controllers 1678 can communicate with one or more haptic devices 1676, such as electroacoustic devices, including a speaker of the one or more speakers 1674 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 1678 can provide haptic events to that are capable of being sensed by a user of watch body 1520. In some embodiments, one or more haptic controllers 1678 can receive input signals from an application of applications 1682.

In some embodiments, wearable band computing system 1630 and/or watch body computing system 1660 can include memory 1680, which can be controlled by one or more memory controllers of controllers 1677. In some embodiments, software components stored in memory 1680 include one or more applications 1682 configured to perform operations at the watch body 1520. In some embodiments, one or more applications 1682 may include games, word processors, messaging applications, calling applications, web browsers, social media applications, media streaming applications, financial applications, calendars, clocks, etc. In some embodiments, software components stored in memory 1680 include one or more communication interface modules 1683 as defined above. In some embodiments, software components stored in memory 1680 include one or more graphics modules 1684 for rendering, encoding, and/or decoding audio and/or visual data and one or more data management modules 1685 for collecting, organizing, and/or providing access to data 1687 stored in memory 1680. In some embodiments, one or more of applications 1682 and/or one or more modules can work in conjunction with one another to perform various tasks at the watch body 1520.

In some embodiments, software components stored in memory 1680 can include one or more operating systems 1681 (e.g., a Linux-based operating system, an Android operating system, etc.). Memory 1680 can also include data 1687. Data 1687 can include profile data 1688A, sensor data 1689A, media content data 1690, and application data 1691.

It should be appreciated that watch body computing system 1660 is an example of a computing system within watch body 1520, and that watch body 1520 can have more or fewer components than shown in watch body computing system 1660, can combine two or more components, and/or can have a different configuration and/or arrangement of the components. The various components shown in watch body computing system 1660 are implemented in hardware, software, firmware, or a combination thereof, including one or more signal processing and/or application-specific integrated circuits.

Turning to the wearable band computing system 1630, one or more components that can be included in wearable band 1510 are shown. Wearable band computing system 1630 can include more or fewer components than shown in watch body computing system 1660, can combine two or more components, and/or can have a different configuration and/or arrangement of some or all of the components. In some embodiments, all, or a substantial portion of the components of wearable band computing system 1630 are included in a single integrated circuit. Alternatively, in some embodiments, components of wearable band computing system 1630 are included in a plurality of integrated circuits that are communicatively coupled. As described above, in some embodiments, wearable band computing system 1630 is configured to couple (e.g., via a wired or wireless connection) with watch body computing system 1660, which allows the computing systems to share components, distribute tasks, and/or perform other operations described herein (individually or as a single device).

Wearable band computing system 1630, similar to watch body computing system 1660, can include one or more processors 1649, one or more controllers 1647 (including one or more haptics controllers 1648), a peripherals interface 1631 that can includes one or more sensors 1613 and other peripheral devices, a power source (e.g., a power system 1656), and memory (e.g., a memory 1650) that includes an operating system (e.g., an operating system 1651), data (e.g., data 1654 including profile data 1688B, sensor data 1689B, etc.), and one or more modules (e.g., a communications interface module 1652, a data management module 1653, etc.).

One or more of sensors 1613 can be analogous to sensors 1621 of watch body computing system 1660. For example, sensors 1613 can include one or more coupling sensors 1632, one or more SpO2 sensors 1634, one or more EMG sensors 1635, one or more capacitive sensors 1636, one or more heart rate sensors 1637, and one or more IMU sensors 1638.

Peripherals interface 1631 can also include other components analogous to those included in peripherals interface 1661 of watch body computing system 1660, including an NFC component 1639, a GPS component 1640, an LTE component 1641, a Wi-Fi and/or Bluetooth communication component 1642, and/or one or more haptic devices 1646 as described above in reference to peripherals interface 1661. In some embodiments, peripherals interface 1631 includes one or more buttons 1643, a display 1633, a speaker 1644, a microphone 1645, and a camera 1655. In some embodiments, peripherals interface 1631 includes one or more indicators, such as an LED.

It should be appreciated that wearable band computing system 1630 is an example of a computing system within wearable band 1510, and that wearable band 1510 can have more or fewer components than shown in wearable band computing system 1630, combine two or more components, and/or have a different configuration and/or arrangement of the components. The various components shown in wearable band computing system 1630 can be implemented in one or more of a combination of hardware, software, or firmware, including one or more signal processing and/or application-specific integrated circuits.

Wrist-wearable device 1500 with respect to FIG. 15 is an example of wearable band 1510 and watch body 1520 coupled together, so wrist-wearable device 1500 will be understood to include the components shown and described for wearable band computing system 1630 and watch body computing system 1660. In some embodiments, wrist-wearable device 1500 has a split architecture (e.g., a split mechanical architecture, a split electrical architecture, etc.) between watch body 1520 and wearable band 1510. In other words, all of the components shown in wearable band computing system 1630 and watch body computing system 1660 can be housed or otherwise disposed in a combined wrist-wearable device 1500 or within individual components of watch body 1520, wearable band 1510, and/or portions thereof (e.g., a coupling mechanism 1516 of wearable band 1510).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 1500 can be used in conjunction with a head-wearable device (e.g., AR glasses 1700 and VR system 1810) and/or an HIPD Error! Reference source not found.00 described below, and wrist-wearable device 1500 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR glasses 1700 and VR headset 1810.

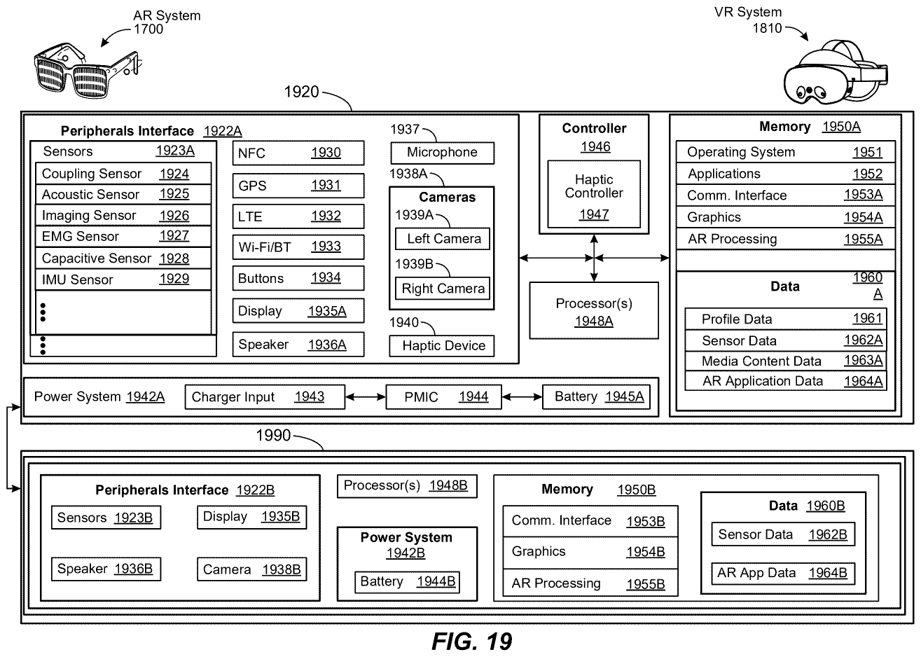

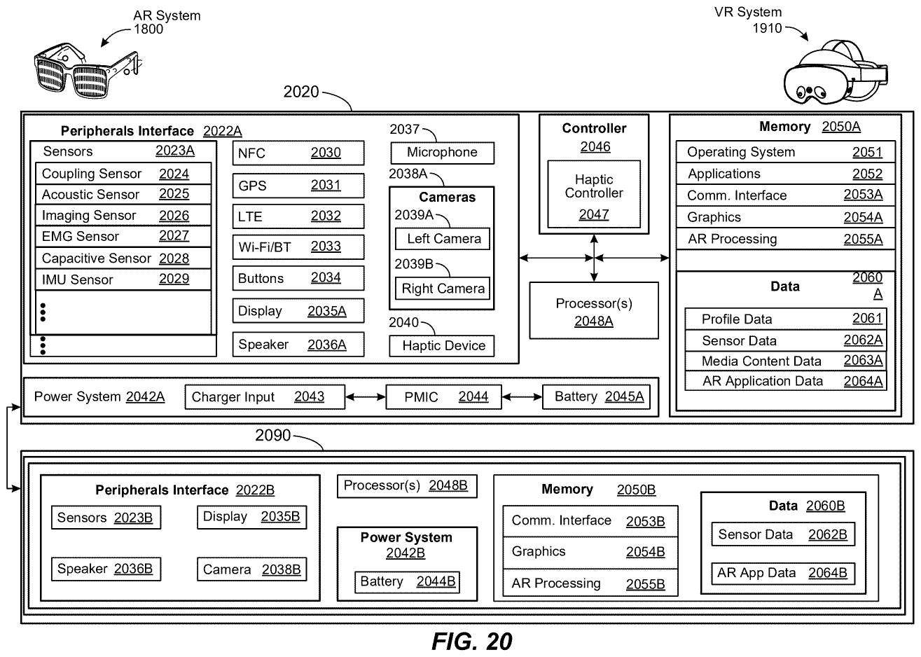

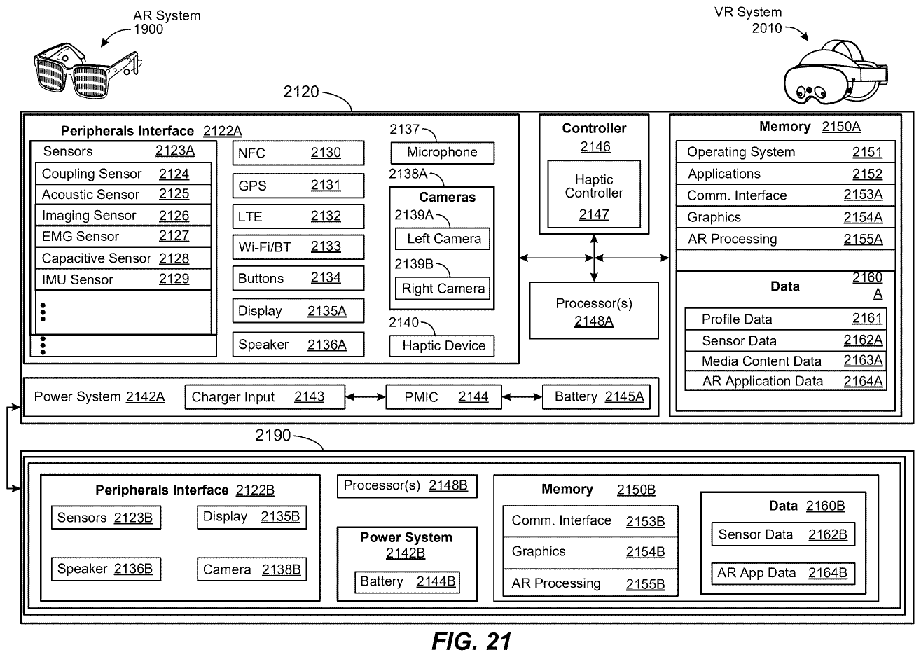

FIGS. 17 to 19 show example artificial-reality systems, which can be used as or in connection with wrist-wearable device 1500. In some embodiments, AR system 1700 includes an eyewear device 1702, as shown in FIG. 17. In some embodiments, VR system 1810 includes a head-mounted display (HMD) 1812, as shown in FIGS. 18A and 18B. In some embodiments, AR system 1700 and VR system 1810 can include one or more analogous components (e.g., components for presenting interactive artificial-reality environments, such as processors, memory, and/or presentation devices, including one or more displays and/or one or more waveguides), some of which are described in more detail with respect to FIG. 19. As described herein, a head-wearable device can include components of eyewear device 1702 and/or head-mounted display 1812. Some embodiments of head-wearable devices do not include any displays, including any of the displays described with respect to AR system 1700 and/or VR system 1810. While the example artificial-reality systems are respectively described herein as AR system 1700 and VR system 1810, either or both of the example AR systems described herein can be configured to present fully-immersive virtual-reality scenes presented in substantially all of a user's field of view or subtler augmented-reality scenes that are presented within a portion, less than all, of the user's field of view.

FIG. 17 show an example visual depiction of AR system 1700, including an eyewear device 1702 (which may also be described herein as augmented-reality glasses, and/or smart glasses). AR system 1700 can include additional electronic components that are not shown in FIG. 17, such as a wearable accessory device and/or an intermediary processing device, in electronic communication or otherwise configured to be used in conjunction with the eyewear device 1702. In some embodiments, the wearable accessory device and/or the intermediary processing device may be configured to couple with eyewear device 1702 via a coupling mechanism in electronic communication with a coupling sensor 1924 (FIG. 19), where coupling sensor 1924 can detect when an electronic device becomes physically or electronically coupled with eyewear device 1702. In some embodiments, eyewear device 1702 can be configured to couple to a housing 1990 (FIG. 19), which may include one or more additional coupling mechanisms configured to couple with additional accessory devices. The components shown in FIG. 17 can be implemented in hardware, software, firmware, or a combination thereof, including one or more signal-processing components and/or application-specific integrated circuits (ASICs).

Eyewear device 1702 includes mechanical glasses components, including a frame 1704 configured to hold one or more lenses (e.g., one or both lenses 1706-1 and 1706-2). One of ordinary skill in the art will appreciate that eyewear device 1702 can include additional mechanical components, such as hinges configured to allow portions of frame 1704 of eyewear device 1702 to be folded and unfolded, a bridge configured to span the gap between lenses 1706-1 and 1706-2 and rest on the user's nose, nose pads configured to rest on the bridge of the nose and provide support for eyewear device 1702, earpieces configured to rest on the user's ears and provide additional support for eyewear device 1702, temple arms configured to extend from the hinges to the earpieces of eyewear device 1702, and the like. One of ordinary skill in the art will further appreciate that some examples of AR system 1700 can include none of the mechanical components described herein. For example, smart contact lenses configured to present artificial reality to users may not include any components of eyewear device 1702.

Eyewear device 1702 includes electronic components, many of which will be described in more detail below with respect to FIG. 19. Some example electronic components are illustrated in FIG. 17, including acoustic sensors 1725-1, 1725-2, 1725-3, 1725-4, 1725-5, and 1725-6, which can be distributed along a substantial portion of the frame 1704 of eyewear device 1702. Eyewear device 1702 also includes a left camera 1739A and a right camera 1739B, which are located on different sides of the frame 1704. Eyewear device 1702 also includes a processor 1748 (or any other suitable type or form of integrated circuit) that is embedded into a portion of the frame 1704.

FIGS. 18A and 18B show a VR system 1810 that includes a head-mounted display (HMD) 1812 (e.g., also referred to herein as an artificial-reality headset, a head-wearable device, a VR headset, etc.), in accordance with some embodiments. As noted, some artificial-reality systems (e.g., AR system 1700) may, instead of blending an artificial reality with actual reality, substantially replace one or more of a user's visual and/or other sensory perceptions of the real world with a virtual experience (e.g., AR systems 1300 and 1400).

HMD 1812 includes a front body 1814 and a frame 1816 (e.g., a strap or band) shaped to fit around a user's head. In some embodiments, front body 1814 and/or frame 1816 include one or more electronic elements for facilitating presentation of and/or interactions with an AR and/or VR system (e.g., displays, IMUs, tracking emitter or detectors). In some embodiments, HMD 1812 includes output audio transducers (e.g., an audio transducer 1818), as shown in FIG. 18B. In some embodiments, one or more components, such as the output audio transducer(s) 1818 and frame 1816, can be configured to attach and detach (e.g., are detachably attachable) to HMD 1812 (e.g., a portion or all of frame 1816, and/or audio transducer 1818), as shown in FIG. 18B. In some embodiments, coupling a detachable component to HMD 1812 causes the detachable component to come into electronic communication with HMD 1812.

FIGS. 18A and 18B also show that VR system 1810 includes one or more cameras, such as left camera 1839A and right camera 1839B, which can be analogous to left and right cameras 1739A and 1739B on frame 1704 of eyewear device 1702. In some embodiments, VR system 1810 includes one or more additional cameras (e.g., cameras 1839C and 1839D), which can be configured to augment image data obtained by left and right cameras 1839A and 1839B by providing more information. For example, camera 1839C can be used to supply color information that is not discerned by cameras 1839A and 1839B. In some embodiments, one or more of cameras 1839A to 1839D can include an optional IR cut filter configured to remove IR light from being received at the respective camera sensors.

FIG. 19 illustrates a computing system 1920 and an optional housing 1990, each of which show components that can be included in AR system 1700 and/or VR system 1810. In some embodiments, more or fewer components can be included in optional housing 1990 depending on practical restraints of the respective AR system being described.

In some embodiments, computing system 1920 can include one or more peripherals interfaces 1922A and/or optional housing 1990 can include one or more peripherals interfaces 1922B. Each of computing system 1920 and optional housing 1990 can also include one or more power systems 1942A and 1942B, one or more controllers 1946 (including one or more haptic controllers 1947), one or more processors 1948A and 1948B (as defined above, including any of the examples provided), and memory 1950A and 1950B, which can all be in electronic communication with each other. For example, the one or more processors 1948A and 1948B can be configured to execute instructions stored in memory 1950A and 1950B, which can cause a controller of one or more of controllers 1946 to cause operations to be performed at one or more peripheral devices connected to peripherals interface 1922A and/or 1922B. In some embodiments, each operation described can be powered by electrical power provided by power system 1942A and/or 1942B.

In some embodiments, peripherals interface 1922A can include one or more devices configured to be part of computing system 1920, some of which have been defined above and/or described with respect to the wrist-wearable devices shown in FIGS. 15 and 16. For example, peripherals interface 1922A can include one or more sensors 1923A. Some example sensors 1923A include one or more coupling sensors 1924, one or more acoustic sensors 1925, one or more imaging sensors 1926, one or more EMG sensors 1927, one or more capacitive sensors 1928, one or more IMU sensors 1929, and/or any other types of sensors explained above or described with respect to any other embodiments discussed herein.

In some embodiments, peripherals interfaces 1922A and 1922B can include one or more additional peripheral devices, including one or more NFC devices 1930, one or more GPS devices 1931, one or more LTE devices 1932, one or more Wi-Fi and/or Bluetooth devices 1933, one or more buttons 1934 (e.g., including buttons that are slidable or otherwise adjustable), one or more displays 1935A and 1935B, one or more speakers 1936A and 1936B, one or more microphones 1937, one or more cameras 1938A and 1938B (e.g., including the left camera 1939A and/or a right camera 1939B), one or more haptic devices 1940, and/or any other types of peripheral devices defined above or described with respect to any other embodiments discussed herein.

AR systems can include a variety of types of visual feedback mechanisms (e.g., presentation devices). For example, display devices in AR system 1700 and/or VR system 1810 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 1935A and 1935B can be coupled to each of the lenses 1706-1 and 1706-2 of AR system 1700. Displays 1935A and 1935B may be coupled to each of lenses 1706-1 and 1706-2, which can act together or independently to present an image or series of images to a user. In some embodiments, AR system 1700 includes a single display 1935A or 1935B (e.g., a near-eye display) or more than two displays 1935A and 1935B. In some embodiments, a first set of one or more displays 1935A and 1935B can be used to present an augmented-reality environment, and a second set of one or more display devices 1935A and 1935B can be used to present a virtual-reality environment. In some embodiments, one or more waveguides are used in conjunction with presenting artificial-reality content to the user of AR system 1700 (e.g., as a means of delivering light from one or more displays 1935A and 1935B to the user's eyes). In some embodiments, one or more waveguides are fully or partially integrated into the eyewear device 1702. Additionally, or alternatively to display screens, some artificial-reality systems include one or more projection systems. For example, display devices in AR system 1700 and/or VR system 1810 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 1935A and 1935B.

Computing system 1920 and/or optional housing 1990 of AR system 1700 or VR system 1810 can include some or all of the components of a power system 1942A and 1942B. Power systems 1942A and 1942B can include one or more charger inputs 1943, one or more PMICs 1944, and/or one or more batteries 1945A and 1944B.

Memory 1950A and 1950B may include instructions and data, some or all of which may be stored as non-transitory computer-readable storage media within the memories 1950A and 1950B. For example, memory 1950A and 1950B can include one or more operating systems 1951, one or more applications 1952, one or more communication interface applications 1953A and 1953B, one or more graphics applications 1954A and 1954B, one or more AR processing applications 1955A and 1955B, and/or any other types of data defined above or described with respect to any other embodiments discussed herein.

Memory 1950A and 1950B also include data 1960A and 1960B, which can be used in conjunction with one or more of the applications discussed above. Data 1960A and 1960B can include profile data 1961, sensor data 1962A and 1962B, media content data 1963A, AR application data 1964A and 1964B, and/or any other types of data defined above or described with respect to any other embodiments discussed herein.

In some embodiments, controller 1946 of eyewear device 1702 may process information generated by sensors 1923A and/or 1923B on eyewear device 1702 and/or another electronic device within AR system 1700. For example, controller 1946 can process information from acoustic sensors 1725-1 and 1725-2. For each detected sound, controller 1946 can perform a direction of arrival (DOA) estimation to estimate a direction from which the detected sound arrived at eyewear device 1702 of AR system 1700. As one or more of acoustic sensors 1925 (e.g., the acoustic sensors 1725-1, 1725-2) detects sounds, controller 1946 can populate an audio data set with the information (e.g., represented in FIG. 19 as sensor data 1962A and 1962B).

In some embodiments, a physical electronic connector can convey information between eyewear device 1702 and another electronic device and/or between one or more processors 1748, 1948A, 1948B of AR system 1700 or VR system 1810 and controller 1946. The information can be in the form of optical data, electrical data, wireless data, or any other transmittable data form. Moving the processing of information generated by eyewear device 1702 to an intermediary processing device can reduce weight and heat in the eyewear device, making it more comfortable and safer for a user. In some embodiments, an optional wearable accessory device (e.g., an electronic neckband) is coupled to eyewear device 1702 via one or more connectors. The connectors can be wired or wireless connectors and can include electrical and/or non-electrical (e.g., structural) components. In some embodiments, eyewear device 1702 and the wearable accessory device can operate independently without any wired or wireless connection between them.

In some situations, pairing external devices, such as an intermediary processing device (e.g., HIPD 1106, 1206, 1306) with eyewear device 1702 (e.g., as part of AR system 1700) enables eyewear device 1702 to achieve a similar form factor of a pair of glasses while still providing sufficient battery and computation power for expanded capabilities. Some, or all, of the battery power, computational resources, and/or additional features of AR system 1700 can be provided by a paired device or shared between a paired device and eyewear device 1702, thus reducing the weight, heat profile, and form factor of eyewear device 1702 overall while allowing eyewear device 1702 to retain its desired functionality. For example, the wearable accessory device can allow components that would otherwise be included on eyewear device 1702 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 1702 standing alone. Because weight carried in the wearable accessory device can be less invasive to a user than weight carried in the eyewear device 1702, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 1700 and/or VR system 1810 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 18A and 18B show VR system 1810 having cameras 1839A to 1839D, which can be used to provide depth information for creating a voxel field and a two-dimensional mesh to provide object information to the user to avoid collisions.

In some embodiments, AR system 1700 and/or VR system 1810 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 1700 and/or VR system 1810, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

In some examples, the augmented reality systems described herein may also include a microphone array with a plurality of acoustic transducers. Acoustic transducers may represent transducers that detect air pressure variations induced by sound waves. Each acoustic transducer may be configured to detect sound and convert the detected sound into an electronic format (e.g., an analog or digital format). A microphone array may include, for example, ten acoustic transducers that may be designed to be placed inside a corresponding ear of the user, acoustic transducers that may be positioned at various locations on an HMD frame a watch band, etc.

In some embodiments, one or more of acoustic transducers may be used as output transducers (e.g., speakers). For example, the artificial reality systems described herein may include acoustic transducers that are earbuds or any other suitable type of headphone or speaker.

The configuration of acoustic transducers of a microphone array may vary and may include any suitable number of transducers. In some embodiments, using higher numbers of acoustic transducers may increase the amount of audio information collected and/or the sensitivity and accuracy of the audio information. In contrast, using a lower number of acoustic transducers may decrease the computing power required by an associated controller to process the collected audio information. In addition, the position of each acoustic transducer of the microphone array may vary. For example, the position of an acoustic transducer may include a defined position on the user, a defined coordinate on a frame of an HMD, an orientation associated with each acoustic transducer, or some combination thereof.

Acoustic transducers and may be positioned on different parts of the user's ear, such as behind the pinna, behind the tragus, and/or within the auricle or fossa. Or, there may be additional acoustic transducers on or surrounding the ear in addition to acoustic transducers inside the ear canal. Having an acoustic transducer positioned next to an ear canal of a user may enable the microphone array to collect information on how sounds arrive at the ear canal. By positioning at least two of acoustic transducers on either side of a user's head (e.g., as binaural microphones), an artificial-reality device may simulate binaural hearing and capture a 3D stereo sound field around about a user's head. In some embodiments, acoustic transducers may be connected to artificial reality systems via a wired connection, and in other embodiments acoustic transducers may be connected to artificial-reality systems via a wireless connection (e.g., a BLUETOOTH connection).

Acoustic transducers may be positioned on HMDs frames in a variety of different ways, including along the length of the temples, across the bridge, above or below display devices, or some combination thereof. Acoustic transducers may also be oriented such that the microphone array is able to detect sounds in a wide range of directions surrounding the user wearing the augmented-reality system. In some embodiments, an optimization process may be performed during manufacturing of augmented-reality system to determine relative positioning of each acoustic transducer in the microphone array.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method, the method comprising:
receiving, by a motion sensor of a wearable device, motion data indicative of user motion;
determining, from the motion data, an auditory zone of interest within an acoustic scene;
capturing, via an audio transducer of the wearable device, audio signals of the acoustic scene; and
rendering audio to the user with selective enhancement of at least one audio signal of the acoustic scene from the auditory zone of interest relative to other audio signals of the acoustic scene.

2. The method of claim 1, wherein the auditory zone of interest corresponds to a speaker of interest in a multi-speaker conversation and rendering selectively enhances speech from the speaker of interest relative to ambient noise.

3. The method of claim 1, wherein determining the auditory zone of interest comprises estimating head orientation from the motion data and classifying the motion data over a time window to predict a discrete spatial sector of the acoustic scene.

4. The method of claim 3, wherein the discrete spatial sector comprises one of a plurality of azimuth bins.

5. The method of claim 1, wherein determining the auditory zone of interest is performed over a short-duration time segment to mitigate sensor drift.

6. The method of claim 1, wherein determining the auditory zone of interest comprises processing the motion data with a machine-learning classifier.

7. The method of claim 1, further comprising determining, from the motion data, a conversational state of the user as listening or speaking and adjusting the rendering based on the conversational state.

8. The method of claim 7, wherein adjusting the rendering based on the conversational state comprises activating own-voice suppression in the speaking state and increasing speech clarity enhancement in the listening state.

9. The method of claim 1, further comprising beamforming the captured audio signals toward the auditory zone of interest and spatializing rendered audio corresponding to the auditory zone of interest relative to other audio.

10. The method of claim 1, wherein capturing the audio signals comprises acquiring ambient audio via a microphone array of the wearable device.

11. The method of claim 1, wherein rendering comprises outputting audio via bilateral transducers of the wearable device.

12. The method of claim 1, wherein the auditory zone of interest is maintained in a world-locked frame of reference independent of instantaneous head pose.

13. The method of claim 1, wherein the motion sensor comprises an inertial measurement unit (IMU) including at least one of a gyroscope, an accelerometer, or a magnetometer.

14. The method of claim 1, wherein the motion sensor comprises a sensor subsystem configured to fuse motion data from at least two of an IMU, an eye-tracking sensor, and a camera.

15. The method of claim 1, further comprising detecting a predetermined gesture from the motion data and triggering an action in response to the predetermined gesture.

16. The method of claim 15, wherein the predetermined gesture comprises at least one of a head nod or a head shake.

17. The method of claim 1, further comprising collecting statistics on user speaking and listening behavior and updating parameters of determining the auditory zone of interest or rendering based on the collected statistics.

18. A wearable device comprising:
at least one physical processor;
a motion sensor communicatively coupled the physical processor;
an audio transducer communicatively coupled to the physical processor; and
physical memory comprising computer-executable instructions that, when executed by the physical processor, cause the physical processor to:
receive, by the motion sensor, motion data indicative of user motion;
determine, from the motion data, an auditory zone of interest within an acoustic scene;
capture, via the audio transducer of the wearable device, audio signals of the acoustic scene; and
render audio to the user with selective enhancement of at least one audio signal of the acoustic scene from the auditory zone of interest relative to other audio signals of the acoustic scene.

19. The wearable device of claim 18, wherein the auditory zone of interest corresponds to a speaker of interest in a multi-speaker conversation and the computer-executable instructions cause the physical processor to render the audio by selectively enhancing speech from a speaker of interest relative to ambient noise.

20. A non-transitory computer-readable medium comprising one or more computer-executable instructions that, when executed by at least one processor of a computing device, cause the computing device to:
receive, by a motion sensor of a wearable device, motion data indicative of user motion;
determine, from the motion data, an auditory zone of interest within an acoustic scene;
capture, via an audio transducer of the wearable device, audio signals of the acoustic scene; and
render audio to the user with selective enhancement of at least one audio signal of the acoustic scene from the auditory zone of interest relative to other audio signals of the acoustic scene.
